(19) United States
(12) Patent Application Publication
(10) Pub. No.: US 2026/0104837 A1
(43) Pub. Date: Apr. 16, 2026

(54) ELECTRONIC DEVICE SHARING SCREEN WITH EXTERNAL ELECTRONIC DEVICE, AND CONTROL METHOD THEREOF

(71) Applicant: Samsung Electronics Co., Ltd., Suwon-si (KR)

(72) Inventors: Bongkyu KIM, Suwon-si (KR); Minki KIM, Suwon-si (KR); Sanghun LEE, Suwon-si (KR); Seungbum LEE, Suwon-si (KR)

(21) Appl. No.: 19/422,944

(22) Filed: Dec. 17, 2025

Related U.S. Application Data
(63) Continuation of application No. PCT/KR2024/011521, filed on Aug. 5, 2024.

(30) Foreign Application Priority Data
Dec. 6, 2023 (KR) 10-2023-0175745
Sep. 27, 2023 (KR) 10-2023-0130447

(51) Int. Cl. G06F 3/14; G06T 3/60

(52) U.S. Cl. CPC G06F 3/1454; G06T 3/60

(57) ABSTRACT

An electronic device is provided. The electronic device includes communication circuitry, a display, a processor, and memory including instructions which, when executed by the processor, cause the electronic device to perform operations given below, wherein the instructions are configured to generate a virtual screen for mirroring a screen displayed on at least a partial region of the display, on the basis of configuration information related to a screen of an external electronic device connected through the communication circuitry, transmit the generated virtual screen to the external electronic device through the communication circuitry, receive changed configuration information from the external electronic device through the communication circuitry while the virtual screen is transmitted, change the virtual screen on the basis of the changed configuration information, and transmit the changed virtual screen to the external electronic device through the communication circuitry.

This application is a continuation application, claiming priority under 35 U.S.C. § 365(c), of an International application No. PCT/KR2024/011521, filed on August 5, 2024, which is based on and claims the benefit of a Korean patent application number 10-2023-0130447, filed on September 27, 2023, in the Korean Intellectual Property Office, and of a Korean patent application number 10-2023-0175745, filed on December 6, 2023, in the Korean Intellectual Property Office, the disclosure of each of which is incorporated by reference herein in its entirety.

### BACKGROUND

### FIELD

The disclosure relates to an electronic device sharing a screen with an external electronic device and a method for controlling the same.

### DESCRIPTION OF RELATED ART

More and more services and additional functions are being provided through electronic devices, e.g., smartphones, or other portable electronic devices. To meet the needs of various users and raise use efficiency of electronic devices, communication service carriers or device manufacturers are jumping into competitions to develop electronic devices with differentiated and diversified functionalities. Accordingly, various functions that are provided through electronic devices are evolving more and more.

Use of an electronic device with a larger screen may give more convenience in, e.g., web browsing or multimedia playing. A larger display may be adopted to output a larger screen. However, this way may be limited by the portability of the electronic device.

To this end, a mirroring function that shares a screen of a first device is being used by transmitting a display screen of the first device (source) to a second device (sink).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device sharing a screen with an external electronic device and a method for controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes communication circuitry, a display, memory, comprising one or more storage media, storing instructions, and one or more processors communicatively coupled to the communication circuitry, the display and the memory, wherein the instructions, when executed by the one or more processors individually or collectively, cause the electronic device to generate a virtual screen for mirroring a screen displayed on at least a partial area of the display based on configuration information related to a screen of an external electronic device connected through the communication circuitry, transmit the generated virtual screen to the external electronic device through the communication circuitry, receive changed configuration information from the external electronic device through the communication circuitry while the virtual screen is being transmitted, change the virtual screen based on the changed configuration information, and transmit the changed virtual screen to the external electronic device through the communication circuitry.

In accordance with an aspect of the disclosure, an electronic device is provided. The electronic device includes communication circuitry, a display, memory, comprising one or more storage media, storing instructions and one or more processors communicatively coupled to the communication circuitry, the display and the memory, wherein the instructions, when executed by the one or more processors individually or collectively, cause the electronic device to receive first screen information related to a virtual screen mirroring a screen of an external electronic device connected through the communication circuitry from the external electronic device, display a first screen generated based on the first screen information on at least a partial area of the display, transmit changed configuration information to the external electronic device based on configuration information of the display being changed while the first screen information is being received, generate a second screen corresponding to the changed configuration information based on second screen information received through the communication circuitry after transmitting the changed configuration information, and display the second screen on the display.

In accordance with another aspect of the disclosure, a method performed by an electronic device is provided. The method includes generating, by the electronic device, a virtual screen for mirroring a screen displayed on at least a partial area of a display of the electronic device based on configuration information related to a screen of an external electronic device connected through communication circuitry of the electronic device, transmitting, by the electronic device, the generated virtual screen to the external electronic device through the communication circuitry, receiving, by the electronic device, changed configuration information from the external electronic device through the communication circuitry while the virtual screen is being transmitted, changing, by the electronic device, the virtual screen based on the changed configuration information, and transmitting, by the electronic device, the changed virtual screen to the external electronic device through the communication circuitry.

The method of controlling the electronic device includes receiving first screen information related to a virtual screen mirroring a screen of an external electronic device connected through a communication circuitry of the electronic device from the external electronic device.

The method of controlling the electronic device includes displaying a first screen generated based on the first screen information on at least a partial area of the display.

The method of controlling the electronic device includes transmitting changed configuration information to the external electronic device based on configuration information of a display of the electronic device being changed while the first screen information is being received.

The method of controlling the electronic device includes generating a second screen corresponding to the changed configuration information based on second screen information received through the communication circuitry after transmitting the changed configuration information.

The method of controlling the electronic device includes displaying the second screen on the display.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include generating, by the electronic device, a virtual screen for mirroring a screen displayed on at least a partial area of a display of the electronic device based on configuration information related to a screen of an external electronic device connected through communication circuitry of the electronic device, transmitting, by the electronic device, the generated virtual screen to the external electronic device through the communication circuitry, receiving, by the electronic device, changed configuration information from the external electronic device through the communication circuitry while the virtual screen is being transmitted, changing, by the electronic device, the virtual screen based on the changed configuration information, and transmitting, by the electronic device, the changed virtual screen to the external electronic device through the communication circuitry.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving first screen information related to a virtual screen mirroring a screen of an external electronic device connected through a communication module of the electronic device from the external electronic device.

The operations include displaying a first screen generated based on the first screen information on at least a partial area of a display of the electronic device.

The operations include transmitting changed configuration information to the external electronic device based on configuration information of the display being changed while the first screen information is being received.

The operations include generating a second screen corresponding to the changed configuration information based on second screen information received through the communication module after transmitting the changed configuration information.

The operations further include displaying the second screen on the display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a view illustrating a mirroring operation when screen settings of an external electronic device are changed during mirroring between an electronic device and an external electronic device according to an embodiment of the disclosure;

FIG. 2B is a view illustrating a mirroring operation when screen settings of an external electronic device are changed during mirroring between an electronic device and an external electronic device according to an embodiment of the disclosure;

FIG. 3A is a view for briefly describing the configuration of an electronic device and an external electronic device according to an embodiment of the disclosure;

FIG. 3B is a flowchart illustrating an operation for a mirroring connection between an electronic device and an external electronic device according to an embodiment of the disclosure;

FIG. 3C is a flowchart illustrating a capability check process between an electronic device and an external electronic device according to an embodiment of the disclosure;

FIG. 4 is a flowchart illustrating an operation of an electronic device changing a mirroring screen according to a configuration change of an external electronic device according to an embodiment of the disclosure;

FIG. 5 is a view illustrating a plurality of mirrorable areas of a screen displayed on an electronic device according to an embodiment of the disclosure;

FIG. 6A is a view illustrating a plurality of mirrorable areas of a screen displayed on an electronic device according to an embodiment of the disclosure;

FIG. 6B is a view illustrating a plurality of mirrorable areas of a screen displayed on an electronic device according to an embodiment of the disclosure;

FIG. 6C is a view illustrating a plurality of mirrorable areas of a screen displayed on an electronic device according to an embodiment of the disclosure;

FIG. 7 is a view illustrating an operation of an electronic device mirroring additional information based on screen settings of an external electronic device according to an embodiment of the disclosure;

FIG. 8 is a flowchart illustrating an operation of an external electronic device displaying a changed mirroring screen according to a configuration change according to an embodiment of the disclosure;

FIG. 9A is a flowchart illustrating an operation of applying a transition effect when an external electronic device displays a changed mirroring screen according to a configuration change according to an embodiment of the disclosure;

FIG. 9B is a flowchart illustrating an operation of an external electronic device applying a transition effect based on a timestamp according to an embodiment of the disclosure;

FIG. 10 is a view illustrating an operation of applying a transition effect when an external electronic device displays a changed mirroring screen according to a configuration change according to an embodiment of the disclosure;

FIG. 11A is a view illustrating an area displaying a mirroring screen of an external electronic device according to an embodiment of the disclosure;

FIG. 11B is a view illustrating an area displaying a mirroring screen of an external electronic device according to an embodiment of the disclosure; and

FIG. 12 is a view illustrating an area displaying a mirroring screen of an external electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

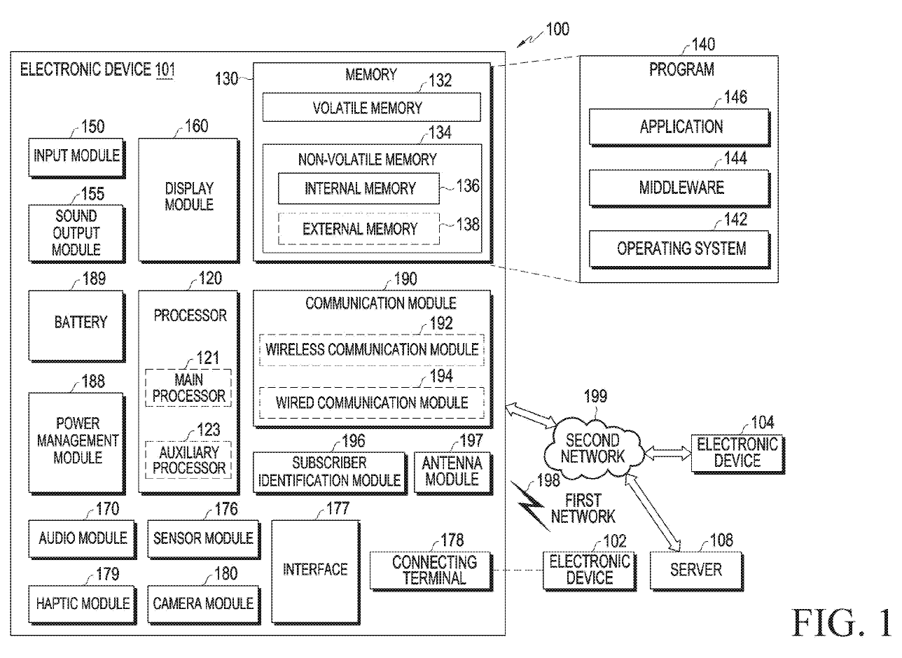

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth^{TM}, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

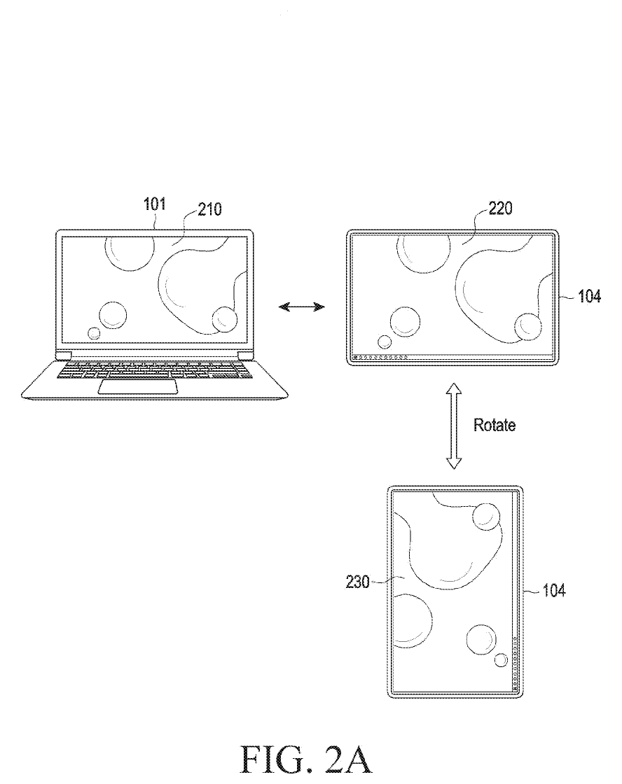

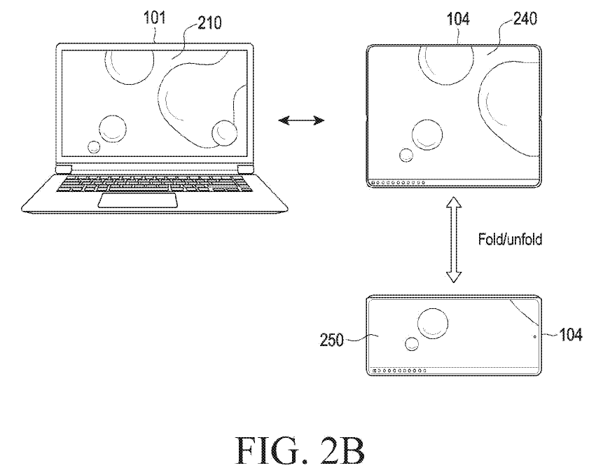

FIG. 2A is a view illustrating a mirroring operation when screen settings of an external electronic device are changed during mirroring between an electronic device and an external electronic device according to an embodiment of the disclosure. For example, FIG. 2A is a view illustrating a mirroring operation when screen settings are changed as the external electronic device rotates.

Referring to FIG. 2A, an electronic device 101 (e.g., the electronic device 101 of FIG. 1) (e.g., a source device) may perform screen sharing with an external electronic device 104 (e.g., the electronic device 104 of FIG. 1) (e.g., a sink device). For example, the electronic device 101 may transmit screen information of a first screen 210 displayed on a display of the electronic device 101 (e.g., the display module 160 of FIG. 1) (e.g., a source screen) to the external electronic device 104. For example, the screen information may be information about a virtual screen mirroring at least a partial area of the first screen 210. For example, the information about the virtual screen may include a stream of video data to be displayed on the external electronic device 104.

According to an embodiment, the external electronic device 104 may display a second screen 220 on a display of the external electronic device 104 (e.g., a sink screen) based on the screen information received from the electronic device 101. According to an embodiment, the second screen 220 may be a screen mirroring the first screen 210.

According to an embodiment, configuration information of the external electronic device 104 may be changed as the external electronic device 104 rotates. For example, the configuration information may include a ratio of a screen displayed on the external electronic device 104, a horizontal/vertical length of the screen, and/or a resolution of the screen.

According to an embodiment, the electronic device 101 may receive the changed configuration information of the external electronic device 104 from the external electronic device 104. The electronic device 101 may change screen information of a virtual screen mirroring the first screen 210 based on the changed configuration information of the external electronic device 104. For example, the electronic device 101 may change a ratio of the virtual screen mirroring the first screen 210, a horizontal/vertical length of the virtual screen, and/or a resolution of the virtual screen based on the changed configuration information of the external electronic device 104. According to an embodiment, as illustrated in FIG. 2A, the electronic device 101 may shorten the horizontal length of the virtual screen and lengthen the vertical length based on the horizontal length becoming shorter and the vertical length becoming longer according to the rotation of the external electronic device 104.

According to an embodiment, the electronic device 101 may transmit the changed screen information to the external electronic device 104. The external electronic device 104 may display a third screen 230 based on the changed screen information. According to an embodiment, the third screen 230 may be a screen mirroring at least a partial area of the first screen 210.

FIG. 2B is a view illustrating a mirroring operation when screen settings of an external electronic device are changed during mirroring between an electronic device and an external electronic device according to an embodiment of the disclosure. For example, FIG. 2B is a view illustrating a mirroring operation when screen settings are changed according to folding or unfolding of the external electronic device.

Referring to FIG. 2B, an electronic device 101 (e.g., the electronic device 101 of FIG. 1) may perform screen sharing with an external electronic device 104 (e.g., the electronic device 104 of FIG. 1). For example, the electronic device 101 may transmit screen information of a first screen 210 displayed on a display of the electronic device 101 (e.g., the display module 160 of FIG. 1) (e.g., a source screen) to the external electronic device 104. For example, the screen information may be information about a virtual screen mirroring at least a partial area of the first screen 210. According to an embodiment, the information about the virtual screen may include, e.g., a stream of video data that the electronic device 101 will display on the external electronic device 104.

According to an embodiment, the external electronic device 104 may display a second screen 240 on a display of the external electronic device 104 (e.g., a sink screen) based on the screen information received from the electronic device 101. According to an embodiment, the second screen 240 may be a screen mirroring the first screen 210.

According to an embodiment, configuration information of the external electronic device 104 may be changed as the external electronic device 104 is folded (or unfolded). For example, the configuration information may include a ratio of a screen displayed on the external electronic device 104, a horizontal/vertical length of the screen, and/or a resolution of the screen.

According to an embodiment, the electronic device 101 may receive the changed configuration information of the external electronic device 104 from the external electronic device 104. The electronic device 101 may change screen information of a virtual screen mirroring the first screen 210 based on the changed configuration information of the external electronic device 104. For example, the electronic device 101 may change a ratio of the virtual screen mirroring the first screen 210, a horizontal/vertical length of the virtual screen, and/or a resolution of the virtual screen based on the changed configuration information of the external electronic device 104. According to an embodiment, as illustrated in FIG. 2B, the electronic device 101 may maintain the horizontal length of the virtual screen and shorten the vertical length based on the horizontal length being maintained and the vertical length being shortened according to the folding of the external electronic device 104.

According to an embodiment, the electronic device 101 may transmit the changed screen information to the external electronic device 104. The external electronic device 104 may display a third screen 250 based on the changed screen information. According to an embodiment, the third screen 250 may be a screen mirroring at least a partial area of the first screen 210.

Although the external electronic device 104 is illustrated as a bar-type or foldable device in FIGS. 2A and 2B, the type of the external electronic device 104 may also be a virtual reality (VR) (or augmented reality (AR)) device or a rollable device.

According to an embodiment, although the entire screen of the electronic device 101 is illustrated as being shared with the external electronic device 104 in FIGS. 2A and 2B, one window among multi-window screens or a pop-up screen of the electronic device 101 may be mirrored, and the mirrored screen may be displayed on a partial area of the display of the external electronic device 104.

As such, the electronic device may provide screen information for mirroring based on the configuration information of the external electronic device that receives the shared screen, and may provide changed screen information for mirroring according to changes in the configuration information of the external electronic device.

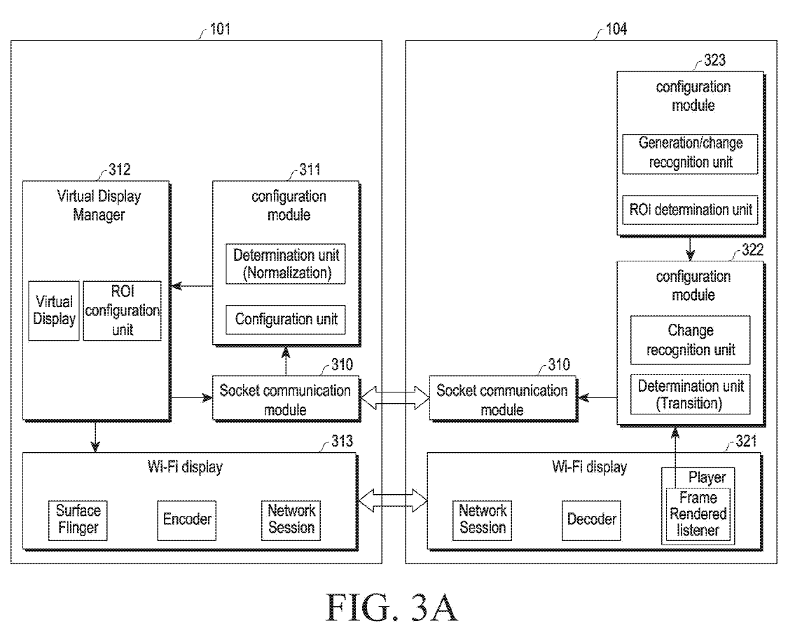

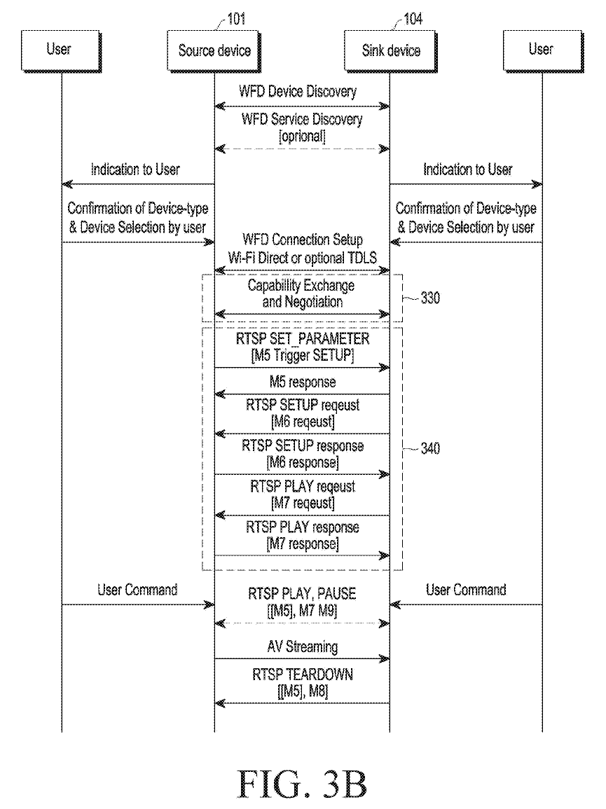

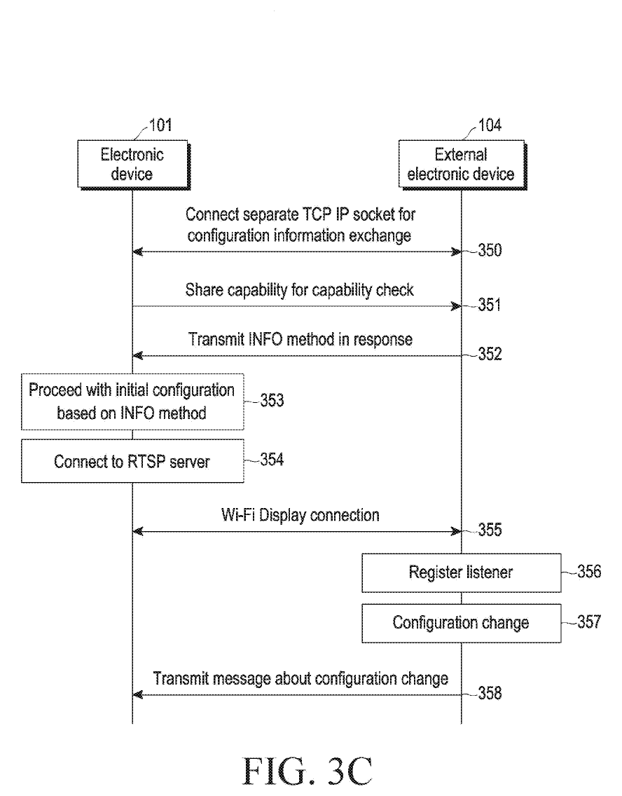

FIG. 3A is a view for briefly describing the configuration of an electronic device and an external electronic device according to an embodiment of the disclosure.

Referring to FIG. 3A, an electronic device 101 (e.g., the electronic device 101 of FIG. 1 or the processor 120 of FIG. 1) (e.g., a source device) may include a socket communication module 310 (e.g., the communication module 190 of FIG. 1), a configuration module 311, a virtual display manager 312, and a Wi-Fi display 313.

According to an embodiment, the socket communication module 310 may include a TCP network socket communication module for exchanging configuration information in a message format. According to an embodiment, the socket communication module 310 may be separate from a communication module that transmits and receives display data (e.g., the Wi-Fi display 313).

According to an embodiment, the socket communication module 310 may receive configuration information of an external electronic device 104 (e.g., the electronic device 104 of FIG. 1) (e.g., a sink device). According to an embodiment, the socket communication module 310 may forward the configuration information of the external electronic device 104 received from the external electronic device 104 to the configuration module 311.

According to an embodiment, the configuration information may be configuration information related to a display area of the external electronic device 104 where a virtual screen is displayed. According to an embodiment, the configuration information may include at least one of a number, a position, a size, and a resolution of display areas where the virtual screen is displayed.

According to an embodiment, the configuration module 311 may perform normalization of different configuration ranges and values between heterogeneous devices and configuration for corrected configuration values.

According to an embodiment, the configuration module 311 may include a determination unit and a configuration unit. According to an embodiment, the determination unit of the configuration module 311 may correct the received configuration information to be normalized based on differences in configuration ranges and configuration values for each configuration information.

According to an embodiment, the configuration unit of the configuration module 311 may perform configuration of configuration values for each configuration information based on the corrected configuration range and configuration values.

According to an embodiment, the virtual display manager 312 may manage multiple virtual screens that are created or deleted according to the number of displays and/or the number of windows of the external electronic device 104 and, when two or more virtual screens are created, may set content to be displayed in a region of interest (ROI) area to be transmitted to each screen.

According to an embodiment, when the electronic device 101 includes a plurality of displays, includes a plurality of windows, or mirrors only a partial area of a screen displayed on the electronic device 101, an area to be created as a virtual screen may be set by the ROI setting unit of the virtual display manager 312. For example, the ROI setting unit of the virtual display manager 312 may set a display, window, or area that a user is viewing through the user's gaze tracking as an area to be created as a virtual screen.

According to an embodiment, when the configuration information received from the external electronic device 104 includes two or more displays and/or windows and includes information about the position of each display and/or window, the virtual display manager 312 may determine a display and/or window of the external electronic device 104 where at least one created virtual screen is displayed.

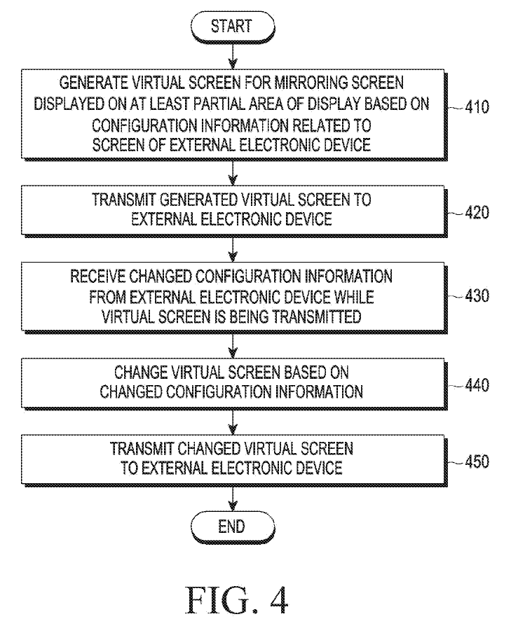

For example, the virtual display manager 312 may perform 1:N, N:1, or N:N mirroring operations based on the number of screens of the electronic device 101 (e.g., display and/or window) to be created as virtual screens and the number of screens of the external electronic device 104 where virtual screens is displayed. According to an embodiment, when there are multiple external electronic devices 104 performing mirroring operations with the electronic device 101, or when one external electronic device 104 has multiple displays and/or windows to perform mirroring, a capability check may be performed to identify configuration information applicable to each external electronic device 104. According to an embodiment, each external electronic device 104 may manage configuration changes and perform mirroring with the electronic device 101 according to set determination conditions. According to an embodiment, 1:N, N:1, or N:N mirroring operations is described below in more detail with reference to FIG. 4.

According to an embodiment, the virtual display manager 312 may transmit screen information about at least one created virtual screen to the external electronic device 104through the Wi-Fi display 313. For example, the Wi-Fi display 313 may encode at least one virtual screen created by the virtual display manager 312 and transmit it to the external electronic device 104 through a network session.

According to an embodiment, an external electronic device 104 (e.g., the electronic device 104 of FIG. 1) (e.g., a sink device) may include a socket communication module 320, a Wi-Fi display 321, a configuration module 322, and a display/window module 323.

According to an embodiment, the socket communication module 320 may transmit configuration information to the electronic device 101. According to an embodiment, the socket communication module 320 may transmit configuration information received from the configuration module 322 to the electronic device 101.

According to an embodiment, the configuration information may be configuration information related to an area where a virtual screen of the external electronic device 104 is displayed. According to an embodiment, the configuration information may include at least one of a number, a position, a size, and a resolution of areas where the virtual screen is displayed.

According to an embodiment, the Wi-Fi display 321 may perform rendering by decoding virtual screen information received from the electronic device 101. According to an embodiment, the Wi-Fi display 321 may identify a rendering time of a video frame to which changed configuration is applied among screen information received from the electronic device 101 through a frame rendered listener. According to an embodiment, the frame rendered listener may forward information about a rendering time of a video frame to which changed configuration is applied to the configuration module 322.

According to an embodiment, when the configuration module 322 receives information about a video frame to which changed configuration is applied, it may determine whether to apply a screen transition effect and the type of transition effect.

According to an embodiment, the configuration module 322 may recognize configuration changes for each display and/or window. For example, the configuration module 322 may recognize creation, deletion, or change of a display and/or window based on receiving change information from the display/window module 323 based on a display and/or window being created or deleted, a display and/or window being changed by folding or rotation, or an ROI where a virtual screen is displayed being changed by a user's touch input or gaze tracking.

According to an embodiment, the configuration module 322 may forward the changed configuration of the display/window to the socket communication module 320. The external electronic device 104 may transmit the changed configuration information of the display/window to the electronic device 101 through the socket communication module 320.

FIG. 3B is a flowchart illustrating an operation for a mirroring connection between an electronic device and an external electronic device according to an embodiment of the disclosure.

Referring to FIG. 3B, an electronic device 101 (e.g., the electronic device 101 of FIG. 1 or the processor 120 of FIG. 1) (e.g., a source device) may suspend a real-time streaming protocol (RTSP) network connection process 340 for mirroring with an external electronic device 104 (e.g., the electronic device 104 of FIG. 1) (e.g., a sink device) and perform a capability check process 330 before the RTSP network connection process 340.

According to an embodiment, the capability check process 330 may perform a separate TCP connection from communication that transmits and receives display data for exchanging screen configuration information. According to an embodiment, the capability check process 330 may be performed by sharing screen configuration information of the electronic device 101 and screen configuration information of the external electronic device 104 through a TCP connection. According to an embodiment, the capability check process 330 is described below in more detail with reference to FIG. 3C.

FIG. 3C is a flowchart illustrating a capability check process between an electronic device and an external electronic device according to an embodiment of the disclosure.

Referring to FIG. 3C, in operation 350, an electronic device 101 (e.g., the electronic device 101 of FIG. 1 or the processor 120 of FIG. 1) may connect a separate TCP IP socket for exchanging configuration information with an external electronic device 104 (e.g., the electronic device 104 of FIG. 1). For example, the electronic device 101 may connect a TCP IP socket that is separate from a communication module that transmits and receives display data with the external electronic device 104.

According to an embodiment, in operation 351, the electronic device 101 may share capabilities with the external electronic device 104 for a capability check. According to an embodiment, the capabilities may include changeable configuration type information related to a screen (e.g., configuration capability). For example, the changeable configuration type information related to a screen may include a size, ratio, resolution, rotation angle, mirroring target, and mirroring count of a mirroring screen.

According to an embodiment, the electronic device 101 may transmit capabilities to the external electronic device 104 in the following message form (e.g., string form).

[Method] [Version] [CRLF]

[Content-Length] [CRLF]

[Body] [CRLF]

According to an embodiment, during the capability check process, the electronic device 101 may perform message exchange for sharing capabilities of the electronic device 101 and obtaining capabilities of the external electronic device 104 through a GET method. According to an embodiment, a message that the electronic device 101 transmits to the external electronic device 104 through the GET method may be as in the following example.

GET SECOND-SCREEN/1.0

Content-Length:41

Configuration:Rotation|FontSize|Bluelight

According to an embodiment, the external electronic device 104 may store the received configuration type information of the electronic device 101.

According to an embodiment, in operation 352, the external electronic device 104 may transmit an INFO method to the electronic device 101 in response to sharing the capabilities of the electronic device 101. According to an embodiment, the INFO method may include configuration information related to a screen of the external electronic device 104. For example, the external electronic device 104 may transmit configuration information applicable to the external electronic device 104 among the received capabilities of the electronic device 101 to the electronic device 101. For example, the external electronic device 104 may transmit configuration information including size, ratio, resolution information of an area where a mirroring screen is displayed and/or folding or rolling sensing data to the electronic device 101. According to an embodiment, a message that the external electronic device 104 transmits to the electronic device 101 through the INFO method may be as in the following example.

INFO SECOND-SCREEN/1.0

Content-Length:31

Rotation:0

FontSize:3,0-4

According to an embodiment, the electronic device 101 may store the received configuration information of the external electronic device 104.

According to an embodiment, the electronic device 101 and the external electronic device 104 may perform negotiation for mirroring.

According to an embodiment, even when a Wi-Fi Direct P2P connection to the external electronic device 104 is completed, the electronic device 101 may suspend and not immediately proceed with a Wi-Fi display RTSP negotiation process to identify changeable screen configuration type information (e.g., configuration capability).

According to an embodiment, in an RTSP network connection process for a Wi-Fi display connection, the external electronic device 104 as a sink device becomes a network socket client and the electronic device 101 as a source device becomes a network socket server, but the external electronic device 104 may suspend the connection for a display configuration capability check process instead of directly connecting to the electronic device 101.

According to an embodiment, after transmitting changeable screen configuration type information (e.g., configuration capability) to the external electronic device 104 and receiving configuration information from the external electronic device 104, the electronic device 101 may perform negotiation for mirroring.

According to an embodiment, in operation 353, the electronic device 101 may proceed with initial configuration based on the INFO method. For example, the electronic device 101 may create a virtual screen based on configuration information received from the external electronic device 104

According to an embodiment, in operation 354, the electronic device 101 may connect to an RTSP server. According to an embodiment, the external electronic device 104 may become a network socket client, and the electronic device 101 may become a network socket server.

According to an embodiment, in operation 355, the electronic device 101 and the external electronic device 104 may be Wi-Fi display connected. According to an embodiment, the electronic device 101 may transmit a virtual screen to the external electronic device 104.

According to an embodiment, the electronic device 101 may transmit/receive configuration information of the external electronic device 104 through a channel separate from (or a separate TCP socket from) a channel of a communication module that transmits and receives screen information for mirroring with the external electronic device 104. For example, the electronic device 101 may transmit/receive screen information for mirroring (e.g., a mirroring stream) through a first port of Wi-Fi connected with the external electronic device 104, and transmit/receive configuration information through a second port of Wi-Fi.

According to an embodiment, the electronic device 101 may transmit/receive configuration information with the external electronic device 104 through a communication module that communicates in a different manner from a communication module that transmits and receives screen information for mirroring. For example, the electronic device 101 may transmit/receive screen information for mirroring with the external electronic device 104 through a Wi-Fi method, and may also transmit/receive configuration information through a Bluetooth method.

According to an embodiment, in operation 356, when a Wi-Fi display connection is completed, the external electronic device 104 may register a listener. According to an embodiment, the external electronic device 104 may register only listeners for configuration items received from the electronic device 101. The external electronic device 104 may monitor whether corresponding configuration is changed through registered listeners.

According to an embodiment, the external electronic device 104 may display a virtual screen received from the electronic device 101. According to an embodiment, since the virtual screen is created based on configuration information of the external electronic device 104, the virtual screen may be displayed to fill an area where a mirroring screen of the external electronic device 104 is displayed.

According to an embodiment, in operation 357, the configuration of the external electronic device 104 may be changed. For example, the external electronic device 104 may change configuration information based on rotation, folding/unfolding, rolling/unrolling, touch input, gaze tracking, addition of an area to display a mirroring screen, changing an area to display a mirroring screen to another area, and/or changing a size and/or ratio of an area to display a mirroring screen. According to an embodiment, the external electronic device 104 may recognize a configuration change through a listener.

According to an embodiment, in operation 358, the external electronic device 104 may transmit a message about the configuration change to the electronic device 101. According to an embodiment, the external electronic device 104 may transmit the name and value of the changed configuration to the electronic device 101 in a 'key:value' message form.

For example, the external electronic device 104 may transmit a message of the following form to the electronic device 101.

SET SECOND-SCREEN/1.0

Content-Length:11

Rotation:90

According to an embodiment, the external electronic device 104 may transmit the changed configuration information to the electronic device 101 through a second port different from a first port through which a mirroring stream of a communication module is transmitted and received.

According to an embodiment, operations after receiving a message related to changed configuration information from the external electronic device 104 are described below in more detail with reference to FIG. 4.

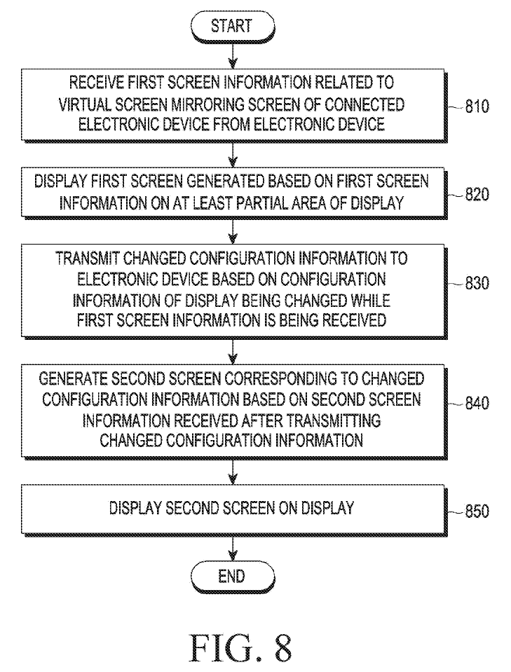

According to an embodiment, operations of the external electronic device 104 after transmitting changed configuration information to the electronic device 101 are described below in more detail with reference to FIG. 8.

FIG. 4 is a flowchart illustrating an operation of an electronic device changing a mirroring screen according to a configuration change of an external electronic device according to an embodiment of the disclosure.

Referring to FIG. 4, in operation 410, an electronic device (e.g., the electronic device 101 of FIG. 1 or the processor 120 of FIG. 1) may generate a virtual screen for mirroring a screen displayed on at least a partial area of a display (e.g., the display module 160 of FIG. 1) based on configuration information related to a screen of an external electronic device (e.g., the electronic device 104 of FIG. 1).

According to an embodiment, the electronic device may perform negotiation for mirroring (e.g., Miracast) with the external electronic device. According to an embodiment, before performing negotiation for mirroring with the external electronic device through a communication module (e.g., the communication module 190 of FIG. 1), the electronic device may transmit information related to types of changeable screen configuration (e.g., configuration capability) to the external electronic device.

According to an embodiment, even when a Wi-Fi Direct P2P connection to the external electronic device is completed, the electronic device may suspend and not immediately proceed with a Wi-Fi display RTSP negotiation process to identify changeable screen configuration type information (e.g., configuration capability). According to an embodiment, in an RTSP network connection process for a Wi-Fi display connection, the external electronic device 104 as a sink device becomes a network socket client and the electronic device 101 as a source device becomes a network socket server, but the external electronic device 104 may suspend the connection for a display configuration capability check process instead of directly connecting to the electronic device 101.

According to an embodiment, in the capability check process, the electronic device may transmit information related to types of changeable screen configuration (e.g., configuration capability) to the external electronic device and then receive configuration information from the external electronic device. According to an embodiment, the configuration information received from the external electronic device may include the number, position, screen ratio, horizontal/vertical length of the screen, and/or screen resolution of displays/windows that may display a mirrored screen in the external electronic device.

According to an embodiment, the electronic device may create a virtual screen for mirroring based on configuration information received from the external electronic device. According to an embodiment, the electronic device (e.g., the virtual display manager 312 of FIG. 3A) may create a virtual screen corresponding to the horizontal length, vertical length, and/or resolution of the display and/or window of the external electronic device based on the received configuration information.

According to an embodiment, when the received configuration information includes multiple displays and/or windows, the electronic device (e.g., the ROI setting unit of the virtual display manager 312 of FIG. 3A) may set an area to be displayed on each display and/or window among content currently displayed on the electronic device 101.

According to an embodiment, based on the electronic device and the external electronic device being heterogeneous devices, the electronic device (e.g., the determination unit of the configuration module 311 of FIG. 3A) may perform correction work (e.g., normalization work) on configuration ranges and values.

According to an embodiment, the electronic device may transmit/receive configuration information of the external electronic device through a channel separate from (or a separate TCP socket from) a channel of a communication module that transmits and receives screen information for mirroring with the external electronic device. For example, the electronic device may transmit/receive screen information for mirroring (e.g., a mirroring stream) through a first port of Wi-Fi connected with the external electronic device, and transmit/receive configuration information through a second port of Wi-Fi.

According to an embodiment, when connecting a separate channel (e.g., TCP socket) for configuration information exchange, the electronic device may perform a capability check process through that channel. According to an embodiment, in the capability check process, the electronic device may transmit screen configuration type information supportable by the electronic device to the external electronic device. According to an embodiment, after transmitting the screen configuration type information to the external electronic device, the electronic device may receive, as a response, configuration information applicable to the external electronic device among the transmitted screen configuration types. According to an embodiment, since the capability check process is the same as operations 350, 351, and 352 of FIG. 3C, duplicate descriptions are omitted.

According to an embodiment, the electronic device may transmit/receive configuration information with the external electronic device through a communication module that communicates in a different manner from a communication module that transmits and receives screen information for mirroring. For example, the electronic device may transmit/receive screen information for mirroring with the external electronic device through a Wi-Fi method, and may also transmit/receive configuration information through a Bluetooth method.

According to an embodiment, the electronic device may perform an operation of setting an area to be mirrored among screens being displayed on the electronic device based on performing mirroring with multiple external electronic devices or based on the number of displays or the number of windows of one external electronic device.

According to an embodiment, in operation 420, the electronic device may transmit the created virtual screen to the external electronic device.

According to an embodiment, in operation 430, while the virtual screen is being transmitted, the electronic device may receive changed configuration information from the external electronic device.

According to an embodiment, the changed configuration information may include a first ratio of a horizontal length and a vertical length of a screen of the external electronic device.

According to an embodiment, the changed configuration information may include rotation information related to a rotation angle of the external electronic device.

According to an embodiment, the changed configuration information may further include second configuration information different from the configuration information. For example, the second configuration information may be configuration information for an additional or created display or window, not an existing display or window of the external electronic device. For example, when a new window is created on a screen of the external electronic device, 1:N or N:N mirroring may be performed.

According to an embodiment, configuration information received from the external electronic device may be a message, and the message may be in a Key:Value format. According to an embodiment, the form of configuration information corresponding to Value may include defined values (e.g., specific numbers such as rotation degree, defined as on or off such as blue light), defined forms (e.g., forms constituted of (number)x(number) such as resolution), and values/value ranges (e.g., minimum-maximum ranges when values are normalized for compatibility between heterogeneous devices, such as font size and screen zoom).

According to an embodiment, the form of configuration information corresponding to Key may include rotation information (e.g., 0, 90, 180, 270), blue light filter (e.g., on or off), dark theme (e.g., on or off), resolution (e.g., width x height), text size (e.g., 1 and 0 (minimum) - 5 (maximum) range), and screen magnification (e.g., 100, 100 (minimum) - 500 (maximum) range).

According to an embodiment, the external electronic device may obtain rotation information through a sensor and identify it as one of 0, 90, 180, or 270 values based on the rotation information, using the default display orientation as '0' as a reference.

According to an embodiment, when receiving a message about configuration information from the external electronic device, the electronic device may obtain (e.g., parse) and store configuration information included in the message.

According to an embodiment, when the electronic device and the external electronic device are homogeneous devices, the electronic device may directly apply the obtained configuration information without separate normalization work. According to an embodiment, when the electronic device and the external electronic device are heterogeneous devices, the electronic device may perform a normalization operation according to different value ranges. For example, the electronic device may obtain a normalized value as a ratio of the configuration value of the external electronic device and (maximum value - minimum value), and may obtain a configuration value for the corresponding configuration through a value obtained by multiplying (maximum value - minimum value) of the corresponding configuration of the electronic device by the normalized value.

For example, when a value related to font size included in configuration information received from the external electronic device is 1 and the range is 0-5, the electronic device may obtain 0.2, which is the ratio of configuration value 1 and (5-0), as a normalized value.

According to an embodiment, when the font range of the electronic device is 0-6, a value 1.2 that has undergone normalization may be obtained by multiplying (6-0) by the normalized value 0.2.

According to an embodiment, the electronic device may transmit the obtained value and range to the external electronic device by including them in screen information of a virtual screen for mirroring.

According to an embodiment, in operation 440, the electronic device may change the virtual screen based on the changed configuration information.

According to an embodiment, the electronic device may change the ratio of the horizontal length and vertical length of the virtual screen based on the ratio of the horizontal length and vertical length of the screen of the external electronic device.

According to an embodiment, the electronic device may change the horizontal length and vertical length of the virtual screen based on rotation information. According to an embodiment, the electronic device may use the direction of the display before rotation as '0' as a reference and identify the rotation information as one of 0, 90, 180, or 270 values based on rotation information obtained by a sensor. According to an embodiment, when the rotation information is 0 or 180, the electronic device may maintain the horizontal length and vertical length. According to an embodiment, when the rotation information is 90 or 270, the electronic device may change the horizontal length before rotation to the vertical length and the vertical length before rotation to the horizontal length.

According to an embodiment, the electronic device may create a second virtual screen based on second configuration information for a new display or window of the external electronic device. According to an embodiment, the second virtual screen may be the same content as an existing virtual screen with only a different ratio, or may be separate content. According to an embodiment, in the case of separate content, the second virtual screen may be a virtual screen of an ROI different from the existing virtual screen among the entire area of the same content, or may be separate content displayed in an area different from the content of the existing virtual screen.

According to an embodiment, the changed virtual screen may further include information indicating that the changed virtual screen reflects the changed configuration information. For example, information indicating that changed configuration information is reflected may be a timestamp. For example, the electronic device may include a timestamp in a frame of a virtual screen created by reflecting changed configuration information. According to an embodiment, the timestamp may be a PTS included in a PES header. The PTS is a 33-bit field with output time information. The PTS value takes only the upper 33 bits as a value with a unit of a period obtained by dividing the system clock frequency (usually 90kHz) by 300. The external electronic device may obtain the output time at the external electronic device by adding the time difference between the PTS and a program clock reference (PCR) value indicating reference time to the system time (real-time clock (RTC)) at the time of PTS reception.

According to an embodiment, in operation 450, the electronic device may transmit the changed virtual screen to the external electronic device. For example, the electronic device may transmit a virtual screen with changed screen ratio, size, or resolution based on configuration information of the external electronic device to the external electronic device.

According to an embodiment, when a new second virtual screen is created, the electronic device may transmit the second virtual screen to the external electronic device.

According to an embodiment, based on receiving changed configuration information including information related to a second area different from a first area corresponding to the virtual screen from the external electronic device, the electronic device may change the virtual screen to a virtual screen for mirroring a screen of the second area.

According to an embodiment, the electronic device may transmit information about a plurality of areas (e.g., a plurality of ROIs) of the display of the electronic device to the external electronic device.

According to an embodiment, the electronic device may transmit information about each of the plurality of areas of the display of the electronic device to different external electronic devices.

According to an embodiment, information about the plurality of areas transmitted to the external electronic device may include thumbnails of mirroring screens of each area. For example, the electronic device may transmit thumbnail screens of a plurality of mirrorable areas to the external electronic device.

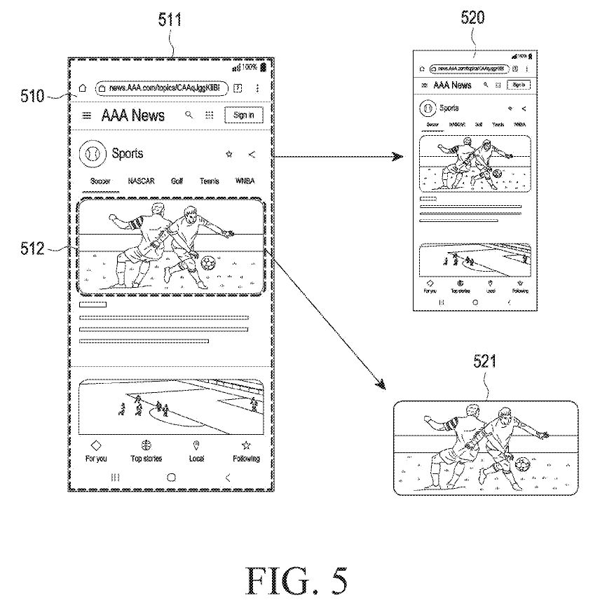

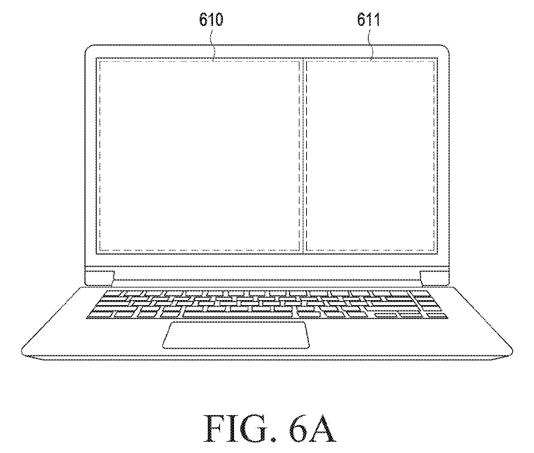

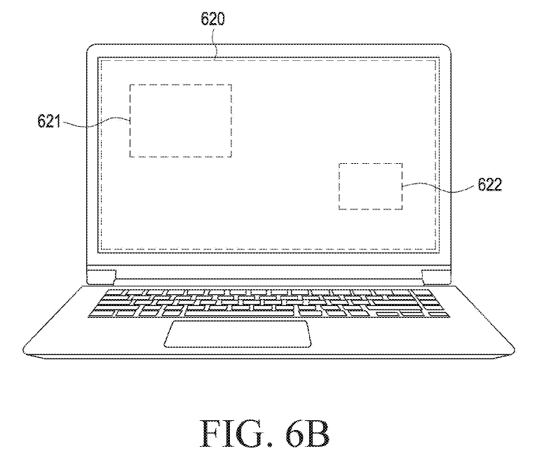

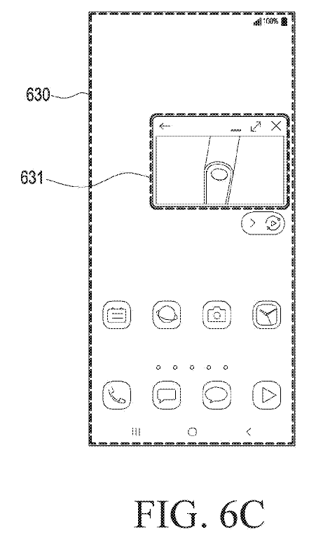

For example, the plurality of areas may be a plurality of ROIs within one content as illustrated in FIG. 5, or may be a plurality of windows displayed on the display of the electronic device as illustrated in FIGS. 6A to 6C. For example, N:1 mirroring or N:N mirroring may be performed, which mirrors screens of two or more areas among the plurality of areas to screens of one or more external electronic devices.

According to an embodiment, types of the plurality of areas of the display of the electronic device is described in more detail with reference to FIGS. 5, 6A, 6B, and 6C below.

According to an embodiment, the external electronic device may display thumbnail screens of the received plurality of areas and allow the user to select a screen to mirror.

According to an embodiment, when the selected screen is different from a screen currently being mirrored, the electronic device may change a screen for existing mirroring to a virtual screen for mirroring a screen of an area corresponding to the selected screen.

According to an embodiment, as a window is added (e.g., picture-in-picture (PIP) form or multi-window form) in the external electronic device, the electronic device may receive configuration information identical to that of an added display from the external electronic device.

For example, when a window is added like a PIP form in the external electronic device, since the existing window is maintained, the electronic device may receive only information about a new window (e.g., second screen).

For example, information about the new window may be as follows.

SET SECOND-SCREEN/1.0

Content-Length:75

Display:Add

DisplayNumber:1

Resolution:1920x1080

Rotation:0

FontSize:3,0-4

Referring to this, information about the new window may include window size (content-length), whether a window is added (display:add), display number, resolution information, rotation information, and font size.

According to an embodiment, when a new window operates as a multi-window, since a size change of an existing window occurs, the electronic device may receive information about a new window (e.g., second screen) and information about a changed existing window.

For example, information about a new window (e.g., second screen) and information about a changed existing window may be as follows.

SET SECOND-SCREEN/1.0

Content-Length:110

Display:Add

DisplayNumber:1

Resolution:640x480

Rotation:0

FontSize:3,0-4

DisplayNmber:0

Resolution:640x480

Referring to this, information about the new window may include window size (content-length), whether a window is added (display:add), display number (e.g., 1), resolution information, rotation information, and font size. Information about the changed existing window may include display number (e.g., 0) and resolution information.

According to an embodiment, when receiving information about a new window from the external electronic device or receiving a user input (e.g., long click) for creating a new window through the display of the electronic device, the electronic device may additionally create a virtual screen.

According to an embodiment, when receiving information about a new window from the external electronic device, if the electronic device is a VR (or AR) device, the electronic device may additionally create a virtual screen mirroring a home screen, a background screen if it is a smartphone or tablet PC, or an extended home screen including a taskbar if it is a PC.

According to an embodiment, a virtual screen transmitted to the external electronic device may be displayed and controlled on the external electronic device. According to an embodiment, when configuration information of the external electronic device is changed (e.g., rotation, folding/unfolding, rolling/unrolling, or window size change), the changed configuration information may be transmitted to the electronic device. The electronic device may change the virtual screen based on the changed configuration information.

According to an embodiment, if the electronic device is a VR (or AR) device where window creation is free, or a smartphone or tablet PC, the electronic device may additionally create a virtual screen to mirror based on a user input (e.g., long click of a second screen function button) while connected with the external electronic device.

According to an embodiment, when the electronic device receives a user input for mirroring multiple screens (e.g., long click of a second screen function button), the electronic device may additionally create a virtual screen identical to the configuration information of an existing virtual screen. According to an embodiment, the additionally created virtual screen may be a virtual screen mirroring a home screen if the electronic device is a VR (or AR) device, a background screen if it is a smartphone or tablet PC, or an extended home screen including a taskbar if it is a PC.

According to an embodiment, the electronic device may transmit information of the added virtual screen to the external electronic device. For example, information of the added virtual screen may be as follows.

INFO SECOND-SCREEN/1.0

Content-Length:24

Display:Add

DisplayNumber:1

According to an embodiment, the external electronic device that has received information of the added virtual screen may provide a menu for selecting a screen to be mirrored. For example, the menu may include a number and/or thumbnail screen of a virtual screen of the electronic device. For example, the number and/or thumbnail screen of the virtual screen of the electronic device may correspond to each of a plurality of areas of the display of the electronic device.

According to an embodiment, when a number and/or thumbnail screen of a virtual screen is selected through control in the external electronic device, the external electronic device may transmit the following information to the electronic device to perform mirroring with the selected virtual screen.

SET SECOND-SCREEN/1.0

Content-Length:12

DisplayNumber:1

According to an embodiment, when the electronic device receives information for changing the added virtual screen to the selected screen from the external electronic device, the electronic device may change from creating a virtual screen based on area 0 of the display to creating based on area 1 of the display.

Accordingly, the electronic device may share screens with the external electronic device while changing areas.

As such, the electronic device may perform 1:N, N:1, or N:N mirroring operations even in 1:1 mirroring operations without additional connection to the external electronic device.

According to an embodiment, 1:N mirroring operation may be an operation of mirroring one source to multiple sinks. For example, the same source screen may be mirrored to multiple sink screens, or sink screens may be mirrored differently according to an ROI area (e.g., face) of the source screen or a ratio of the sink screen (e.g., ratio of horizontal and vertical).

According to an embodiment, the electronic device may mirror different areas of the source screen to each sink screen according to preset conditions (e.g., conditions of mirroring the entire source screen to a sink screen that a user is viewing and mirroring each object of interest included in the source screen to other sink screens, or performing mirroring focused on objects of interest of multiple users).

According to an embodiment, N:1 mirroring operation may be an operation of mirroring multiple source screens together to one sink screen. For example, since multiple source screens should be merged and mirrored to one sink screen, the electronic device may configure source screens to be mirrored differently in various ways according to the screen ratio (e.g., horizontal/vertical ratio) of each source screen or the configuration method of the sink screen.

According to an embodiment, when it is not necessary to display all multiple source screens at once, high-priority source screens may be sequentially mirrored to the sink screen, or only some of the multiple source screens may be selectively mirrored to the sink screen based on preset conditions.

According to an embodiment, N:N mirroring operation may be an operation of mirroring multiple source screens to multiple sink screens. According to an embodiment, the electronic device may make judgments (e.g., policy judgments) on how to arrange multiple source screens based on various logic and judgment conditions.

For example, the electronic device may display a high-priority source screen among multiple source screens (e.g., including a user's object of interest or high-priority content) on the highest-priority sink screen among multiple sink screens (e.g., a sink screen in the direction of the user's gaze through gaze tracking).

According to an embodiment, even during 1:N, N:1, and N:N mirroring operations, when a configuration change of a sink screen of the external electronic device occurs, the changed configuration information is transmitted to the electronic device, and the electronic device may change a virtual screen for mirroring based on the changed configuration information and transmit the changed virtual screen to the external electronic device.

Accordingly, even during 1:N, N:1, and N:N mirroring operations, the electronic device may provide a mirroring screen suitable for the sink screen of the external electronic device.

FIG. 5 is a view illustrating a plurality of mirrorable areas of a screen displayed on an electronic device according to an embodiment of the disclosure.

Referring to FIG. 5, an electronic device (e.g., the electronic device 101 of FIG. 1 or the processor 120 of FIG. 1) may mirror an entire area 511 of content 510 displayed on a display (e.g., the display module 160 of FIG. 1) and/or a partial area 512 of the content 510.

For example, the electronic device may transmit a first virtual screen 520 for mirroring the entire area 511 of the content 510 to an external electronic device (e.g., the electronic device 104 of FIG. 1) based on configuration information of the external electronic device, or transmit a second virtual screen 521 for mirroring the partial area 512 of the content 510 to the external electronic device.

According to an embodiment, when there are multiple external electronic devices or when an external electronic device has multi-windows, the electronic device may transmit both the first virtual screen 520 for mirroring the entire area 511 of the content 510 and the second virtual screen 521 for mirroring the partial area 512 of the content 510 to the external electronic device based on configuration information of multiple screens. According to an embodiment, the first virtual screen 520 and the second virtual screen 521 may be transmitted to the same external electronic device or may be transmitted to different external electronic devices respectively.

FIG. 6A is a view illustrating a plurality of mirrorable areas of a screen displayed on an electronic device according to an embodiment of the disclosure.

Referring to FIG. 6A, when a display (e.g., the display module 160 of FIG. 1) operates as multi-windows, an electronic device (e.g., the electronic device 101 of FIG. 1 or the processor 120 of FIG. 1) may mirror a screen of a first window 610 and/or a screen of a second window 611 to at least one external electronic device (e.g., the electronic device 104 of FIG. 1).

For example, the electronic device may transmit at least one of a virtual screen for mirroring the screen of the first window 610 or a virtual screen for mirroring the screen of the second window 611 to one external electronic device. The electronic device may transmit a virtual screen for mirroring the screen of the first window 610 to a first external electronic device and transmit a virtual screen for mirroring the screen of the second window 611 to a second external electronic device. The electronic device may transmit a virtual screen for mirroring the screen of the first window 610 and a virtual screen for mirroring the screen of the second window 611 to the first external electronic device and the second external electronic device.

FIG. 6B is a view illustrating a plurality of mirrorable areas of a screen displayed on an electronic device according to an embodiment of the disclosure.

Referring to FIG. 6B, the electronic device may mirror a screen of an entire area 620 of content displayed on the display, a screen of a first ROI area 621, and/or a screen of a second ROI area 622 to at least one external electronic device.

For example, the electronic device may transmit at least one of a virtual screen for mirroring the screen of the entire area 620 of the content, a virtual screen for mirroring the screen of the first ROI area 621, or a virtual screen for mirroring the screen of the second ROI area 622 to one external electronic device. The electronic device may transmit a virtual screen for mirroring the screen of the entire area 620 of the content, a virtual screen for mirroring the screen of the first ROI area 621, or a virtual screen for mirroring the screen of the second ROI area 622 to different external electronic devices respectively. The electronic device may transmit a virtual screen for mirroring the screen of the entire area 620 of the content, a virtual screen for mirroring the screen of the first ROI area 621, or a virtual screen for mirroring the screen of the second ROI area 622 to multiple external electronic devices.

FIG. 6C is a view illustrating a plurality of mirrorable areas of a screen displayed on an electronic device according to an embodiment of the disclosure.

Referring to FIG. 6C, when the display includes a pop-up screen, the electronic device may mirror an entire screen 630 except for a pop-up screen 631 and/or the pop-up screen 631 to at least one external electronic device. For example, the entire screen 630 except for the pop-up screen 631 is a case where the pop-up screen 631 is not displayed and may include objects hidden by the pop-up screen 631.

For example, the electronic device may transmit at least one of a virtual screen for mirroring the entire screen 630 except for the pop-up screen 631 or a virtual screen for mirroring the pop-up screen 631 to one external electronic device. The electronic device may transmit a virtual screen for mirroring the entire screen 630 except for the pop-up screen 631 to a first external electronic device and transmit a virtual screen for mirroring the pop-up screen 631 to a second external electronic device. The electronic device may transmit a virtual screen for mirroring the entire screen 630 except for the pop-up screen 631 and a virtual screen for mirroring the pop-up screen 631 to the first external electronic device and the second external electronic device.

According to an embodiment, when displaying an execution screen executed on the electronic device on the pop-up screen 631 (e.g., appcast), although the electronic device does not have a separate external electronic device, the electronic device may use the pop-up screen 631 as a sink screen to mirror the execution screen and display it on the pop-up screen 631. According to an embodiment, the electronic device may omit communication connection and message exchange for transmitting/receiving configuration information and directly control configuration information of a virtual screen of the execution screen. For example, when a screen size and/or screen ratio of the pop-up screen 631 is changed, the electronic device may change configuration information of the virtual screen of the execution screen based on the changed screen size and/or screen ratio and display it on the changed pop-up screen.

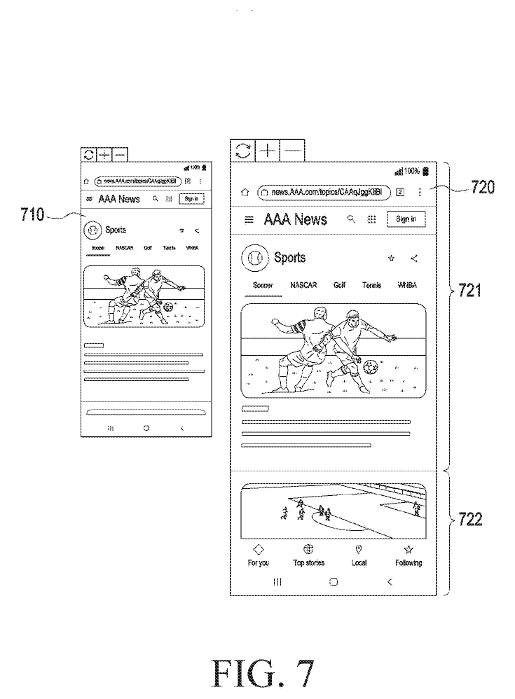

FIG. 7 is a view illustrating an operation of an electronic device mirroring additional information based on screen settings of an external electronic device according to an embodiment of the disclosure.

Referring to FIG. 7, an electronic device (e.g., the electronic device 101 of FIG. 1 or the processor 120 of FIG. 1) may create a virtual screen for mirroring based on a size of a display of an external electronic device (e.g., the electronic device 104 of FIG. 1).

According to an embodiment, when mirroring an execution screen 710 of an application displayed on a display of the electronic device (e.g., the display module 160 of FIG. 1) to a display of an external electronic device 104 that is larger or has a longer vertical length than the display of the electronic device, the electronic device may create a virtual screen 720 that includes additional information, rather than a virtual screen that simply enlarges the execution screen 710 of the application to fit the size of the display of the external electronic device 104.

According to an embodiment, the virtual screen 720 may include an area 721 corresponding to the execution screen 710 of the application and a portion 722 of a screen that is not visible on the display of the electronic device but is visible when the execution screen 710 of the application is scrolled.

Accordingly, when performing mirroring to an external electronic device with a large display, screen space utilization may increase.

For example, when screen zoom is configured in 5 levels, a default resolution of 1080p size may be matched with level 3 which is a default zoom value, and as the display resolution increases, the screen zoom level may decrease by 1 level. For example, 1920 x 1080 may be matched with level 3, 2560 x 1440 may be matched with level 2, and 3840 x 2160 may be matched with level 1.

According to an embodiment, when reaching the corresponding resolution range, the electronic device may also change a screen zoom value matched thereto.

According to an embodiment, the electronic device may transmit to the external electronic device that the resolution has been changed. According to an embodiment, when connected with an external electronic device that is a VR (or AR) device, the electronic device may change a screen zoom level matched to the resolution along with the resolution change and transmit change information to the external electronic device. For example, change information of resolution and screen zoom level may be as follows.

INFO SECOND-SCREEN/1.0

Content-Length:56

Resolution:3840x2160

ScreenZoom:1

TimeStamp:12246772345212

FIG. 8 is a flowchart illustrating an operation of an external electronic device displaying a changed mirroring screen according to a configuration change according to an embodiment of the disclosure.

Referring to FIG. 8, in operation 810, an external electronic device (e.g., the electronic device 104 of FIG. 1) may receive first screen information related to a virtual screen mirroring a screen of a connected electronic device (e.g., the electronic device 101 of FIG. 1) from the electronic device.

According to an embodiment, the external electronic device may perform negotiation for mirroring (e.g., Miracast) with the electronic device. According to an embodiment, before performing negotiation for mirroring with the electronic device through a communication module (e.g., the communication module 190 of FIG. 1), the external electronic device may receive information related to types of changeable screen configuration (e.g., configuration capability) from the electronic device.

According to an embodiment, even when a Wi-Fi Direct P2P connection to the electronic device is completed, the external electronic device may suspend and not immediately proceed with a Wi-Fi display RTSP negotiation process to identify changeable screen configuration type information (e.g., configuration capability). According to an embodiment, in an RTSP network connection process for a Wi-Fi display connection, the external electronic device as a sink device becomes a network socket client and the electronic device as a source device becomes a network socket server, but the external electronic device 104 may suspend the connection for a display configuration capability check process instead of directly connecting to the electronic device.

According to an embodiment, after receiving information related to types of changeable screen configuration (e.g., configuration capability) from the electronic device, the external electronic device may transmit configuration information to the electronic device. For example, the configuration information may include size, ratio, and/or resolution information of an area (e.g., entire, window, or pop-up screen) where a mirrored screen is displayed on the display of the external electronic device. According to an embodiment, when there are multiple areas where a mirrored screen is displayed on the display of the external electronic device, the configuration information may further include identification information of the area (e.g., display number).

According to an embodiment, after transmitting the configuration information to the electronic device, the external electronic device may receive first screen information related to a virtual screen mirroring from the electronic device. For example, the first screen information related to the mirroring virtual screen may be created based on configuration information of the external electronic device.

According to an embodiment, in operation 820, the external electronic device may display a first screen generated based on the first screen information on at least a partial area of the display.

According to an embodiment, since the first screen information is created based on configuration information of the external electronic device, the first screen may be displayed to fill the entire display, window, or pop-up screen of the external electronic device.

According to an embodiment, in operation 830, while the first screen information is being received, the external electronic device may transmit changed configuration information to the electronic device based on configuration information of the display being changed.

According to an embodiment, the external electronic device may change configuration information according to rotation, folding/unfolding, or rolling/unrolling of the external electronic device.

According to an embodiment, the external electronic device may change configuration information based on a change of an area (e.g., window) to display a mirroring screen (e.g., a screen generated based on screen information received from the electronic device).

According to an embodiment, the external electronic device may change configuration information based on rotation of the display and change of a window to display a screen generated based on the screen information (e.g., touch or gaze tracking).

For example, the configuration information may include a size, horizontal-to-vertical ratio, resolution, and/or rotation angle of an area to display a mirroring screen.

According to an embodiment, when the external electronic device is a foldable electronic device or a rollable electronic device, configuration information may be changed according to a folding angle or rolling degree. For example, an external electronic device that is a foldable electronic device may be fully folded so that an external display displays a mirroring screen, or may be half-folded to operate in a flex mode where only half of the display displays a mirroring screen. According to an embodiment, the external electronic device may identify that the resolution has changed, change configuration information to a value that reduces the width of the size of the area to display a mirroring screen by half, and transmit the changed configuration information to the electronic device.

According to an embodiment, when an area to display a mirroring screen is changed from the entire area of the display to a PIP screen, the external electronic device may transmit information about the PIP screen to the electronic device.

According to an embodiment, while the first screen information is being received, the external electronic device may change configuration information based on receiving a user input for changing an area where the first screen is displayed. For example, a user input for changing an area where the first screen is displayed may be selecting another area among multiple areas or changing an ROI.

According to an embodiment, the external electronic device may receive information about a plurality of areas of the display of the electronic device from the electronic device. For example, information about the plurality of areas may include identification information (e.g., window identification information, ROI identification information) and/or thumbnail screens of mirrorable areas in the electronic device.

According to an embodiment, the external electronic device may display information about the plurality of areas on the display.

According to an embodiment, based on receiving a user input selecting a second area different from a first area corresponding to the first screen among the plurality of areas, the external electronic device may change configuration information to include information related to the second area. For example, the second area may be different content from the first area corresponding to the existing mirroring screen, the first screen, or may be a different ROI within the same content.

According to an embodiment, in operation 840, the external electronic device may generate a second screen corresponding to the changed configuration information based on second screen information received after transmitting the changed configuration information.

According to an embodiment, the second screen information may further include information indicating that the changed configuration information is reflected. For example, information indicating that changed configuration information is reflected may be a timestamp and may be included in a frame to which changed configuration information is reflected.

According to an embodiment, in operation 850, the external electronic device may display the second screen on the display.

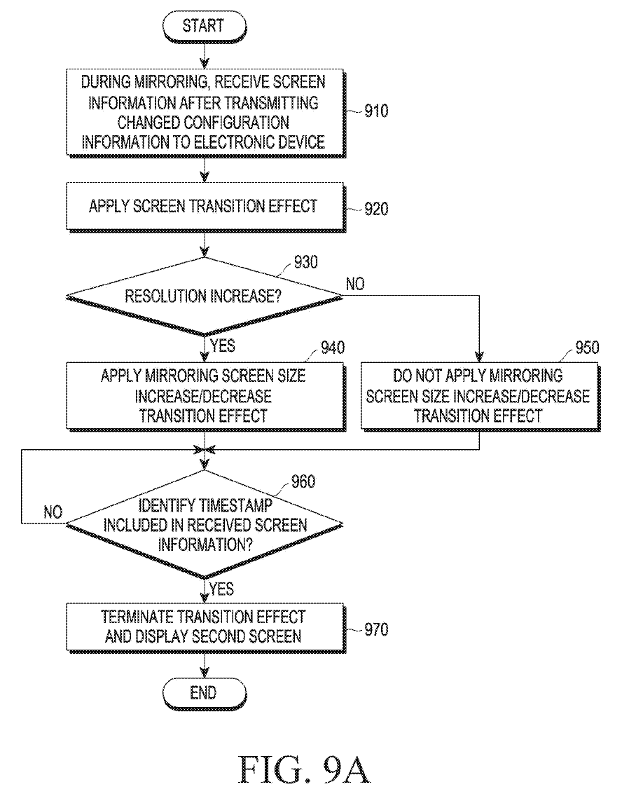

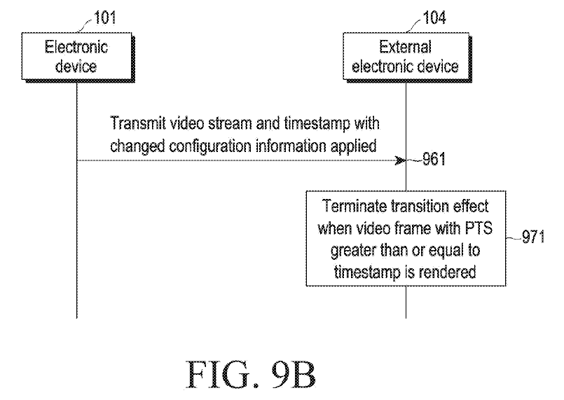

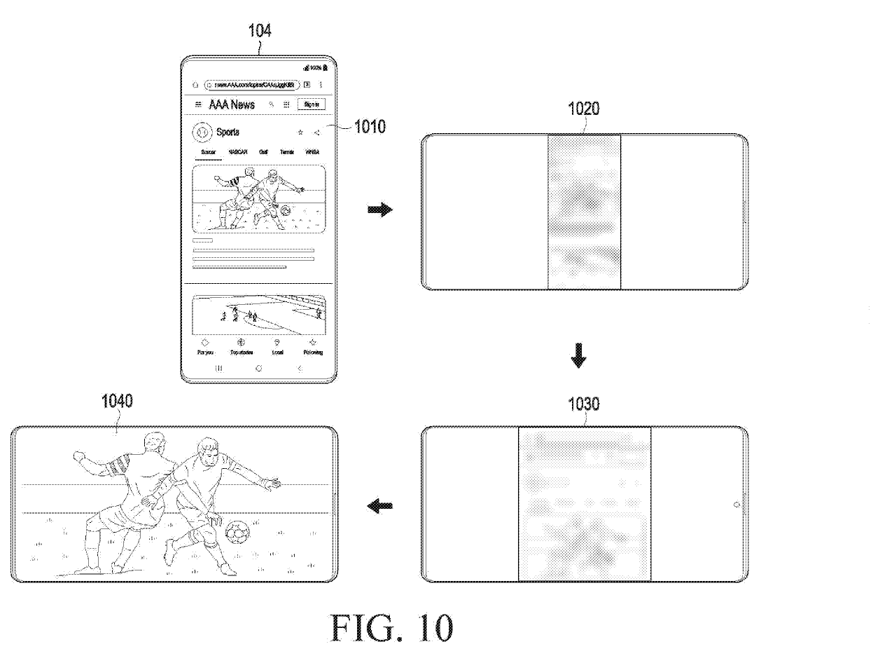

According to an embodiment, after changing configuration information of the display, the external electronic device may provide a transition effect to the first screen. For example, the transition effect may include a blur transition effect that blurs the first screen. According to an embodiment, when a resolution is changed and a size change of a mirroring screen is necessary, the transition effect may further include a transition effect that adjusts the size of the first screen. According to an embodiment, a transition effect provided before the second screen information is received is described in more detail with reference to FIGS. 9A, 9B, and 10 below.

According to an embodiment, based on receiving second screen information including a timestamp, the external electronic device may terminate the transition effect and display the second screen.

As such, by providing a transition effect before receiving a mirroring screen reflecting changed configuration information after changing display configuration information, the temporary abnormal screen ratio experience that occurs when changing configuration information may be decreased.

According to an embodiment, when the external electronic device is a rollable electronic device, continuous configuration information changes may occur according to rolling or unrolling. According to an embodiment, the external electronic device may delay the release timing of the transition effect for a set time (e.g., 300ms) rather than the time when the second screen information including the timestamp is received.

According to an embodiment, the external electronic device may identify whether there is a change in configuration information before releasing the transition effect, and if there is no change, may release the transition effect. According to an embodiment, if there is a change in configuration information before releasing the transition effect, the external electronic device may not release the transition effect, delay for the set time, and then identify again whether configuration information has changed.

FIG. 9A is a flowchart illustrating an operation of applying a transition effect when an external electronic device displays a changed mirroring screen according to a configuration change according to an embodiment of the disclosure.

FIG. 9B is a flowchart illustrating an operation of an external electronic device applying a transition effect based on a timestamp according to an embodiment of the disclosure.

Referring to FIG. 9A, in operation 910, during mirroring, an external electronic device (e.g., the electronic device 104 of FIG. 1) may receive screen information after transmitting changed configuration information to an electronic device (e.g., the electronic device 101 of FIG. 1). For example, after transmitting changed configuration information, the external electronic device may receive screen information to which the changed configuration information is not reflected.

According to an embodiment, in operation 920, the external electronic device may apply a screen transition effect (e.g., blur transition effect, quick slide transition effect, or morph transition effect). For example, a blur transition effect may be an effect that makes a screen appear blurry. The blur transition effect is merely an example of a screen transition effect and is not limited thereto.

According to an embodiment, in operation 930, the external electronic device may identify whether the resolution of the received screen information increases or decreases.

According to an embodiment, if the resolution of the display increases or decreases (operation 930 - Yes), in operation 940, the external electronic device may apply a mirroring screen size increase/decrease transition effect. For example, when a configuration information change includes a resolution increase or decrease, the external electronic device may apply a transition effect that increases or decreases the size of the received screen information. According to an embodiment, the external electronic device may first apply a blur transition effect to the received screen information and then apply a dynamic transition effect where the size gradually increases or decreases. For example, the external electronic device may first apply a blur transition effect to the received screen information and then apply an animation that increases the size after rendering of a frame to which changed configuration is applied is completed.

According to an embodiment, according to a resolution change, the external electronic device may identify the size and coordinates of an area where a mirroring screen is displayed, and gradually change the size and position of a screen generated based on the received screen information to the identified size and coordinates over a set time (e.g., 300ms). For example, the external electronic device may identify the layout size and coordinates that need to be changed according to the changed resolution, and gradually change the screen size from x, y coordinates of each corner of a screen (surface view) generated based on a video stream received from the electronic device to x1, y1 coordinates of each corner that needs to be changed over a set time (e.g., 300ms).

According to an embodiment, even when the external electronic device is a foldable device where screen ratios of an internal display and an external display are different, a registered listener (e.g., frame rendered listener of the Wi-Fi display 321 of FIG. 3A) recognizes the resolution change of the display that changes during folding or unfolding and forwards it to the electronic device, so the electronic device may provide a virtual screen with changed virtual screen resolution settings. According to an embodiment, the external electronic device may apply a screen transition effect until identifying virtual screen information with changed resolution settings after folding or unfolding.

According to an embodiment, if there is no increase or decrease in resolution of the received screen information (operation 930 - No), in operation 950, the external electronic device may not apply a mirroring screen size decrease transition effect.

According to an embodiment, when the resolution is not changed, the external electronic device may apply only a blur transition effect to the mirroring screen and not apply a size increase/decrease transition effect.

According to an embodiment, in operation 960, the external electronic device may identify a timestamp included in the received screen information.

According to an embodiment, the external electronic device may identify a timestamp included in a frame of the mirroring screen. For example, the timestamp may indicate that changed configuration information is reflected.

According to an embodiment, as illustrated in FIG. 9B, in operation 961, the electronic device 101 may transmit a video stream (e.g., frame) to which changed configuration information is applied and a timestamp to the external electronic device 104.

According to an embodiment, the timestamp may be a PTS included in a PES header. According to an embodiment, the external electronic device 104 may identify whether a PTS is included in a PES header of a video stream received from the electronic device 101.

According to an embodiment, if a timestamp is not included in the received screen information (operation 960 - No), the external electronic device may repeat the operation of identifying whether a timestamp is included in the received screen information. For example, the external electronic device may repeat identifying whether a timestamp is included while providing a blur transition effect and/or size increase/decrease transition effect to the received screen information.

According to an embodiment, if a timestamp is included in the received screen information (operation 960 - Yes), in operation 970, the external electronic device may terminate the transition effect and display the second screen.

According to an embodiment, based on receiving screen information reflecting changed configuration information, the external electronic device may terminate the transition effect and display a second screen generated based on screen information reflecting the changed configuration information.

According to an embodiment, as illustrated in FIG. 9B, in operation 971, when a video frame having a PTS greater than or equal to a timestamp is rendered, the external electronic device 104 may terminate the transition effect.

According to an embodiment, the external electronic device 104 may obtain an output time of a video frame at the external electronic device 104 by adding a time difference between the PTS and a PCR value indicating reference time to a system time (RTC) at the time of PTS reception.

As such, the external electronic device may provide an effect to make abnormal screen output that occurs before changed configuration information is reflected appear relatively natural.

FIG. 10 is a view illustrating an operation of applying a transition effect when an external electronic device displays a changed mirroring screen according to a configuration change according to an embodiment of the disclosure.

Referring to FIG. 10, an external electronic device 104 (e.g., the electronic device 104 of FIG. 1) may display a first mirroring screen 1010. According to an embodiment, when configuration information is changed based on rotation, the external electronic device 104 may transmit the changed configuration information to an electronic device (e.g., the electronic device 101 of FIG. 1), and display a second mirroring screen 1020 that provides a blur transition effect based on screen information received before the changed configuration information is reflected.

According to an embodiment, the second mirroring screen 1020 may be in a decreased size state so that the entire mirroring screen based on screen information received by the rotated external electronic device is displayed. According to an embodiment, the external electronic device may display a monochrome (e.g., black) screen in areas other than the area where the second mirroring screen 1020 is displayed.

According to an embodiment, the external electronic device may display a third mirroring screen 1030 that gradually increases in size by applying a blur transition effect and a size increase transition effect. According to an embodiment, as the size of the third mirroring screen 1030 gradually increases, a portion of the mirroring screen based on the received screen information may not be displayed.

According to an embodiment, while the third mirroring screen 1030 reflecting the blur transition effect and size increase transition effect is displayed, based on receiving screen information reflecting changed configuration information, the external electronic device may terminate the transition effect and display a fourth mirroring screen 1040 generated based on screen information reflecting the changed configuration information. According to an embodiment, since the fourth mirroring screen 1040 is created by reflecting changed configuration information, it may be displayed to fill an area (e.g., entire or portion of the display) for displaying a mirroring screen.

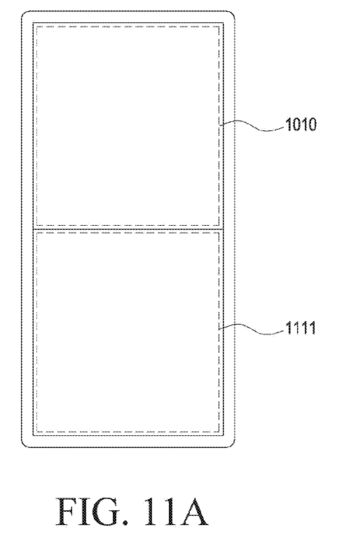

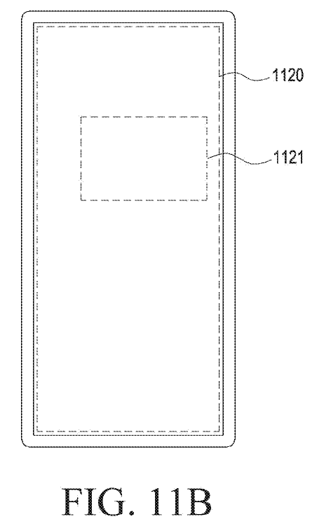

FIG. 11A is a view illustrating an area displaying a mirroring screen of an external electronic device according to an embodiment of the disclosure.

Referring to FIG. 11A, an external electronic device (e.g., the electronic device 104 of FIG. 1) may display a plurality of mirroring screens received from one electronic device (e.g., the electronic device 101 of FIG. 1) or multiple electronic devices.

For example, when a screen of the external electronic device is in a multi-window state including multiple windows, the external electronic device may display a first mirroring screen 1110 in a first window and display a second mirroring screen 1111 in a second window.

For example, when the first mirroring screen 1110 and the second mirroring screen 1111 are received from one electronic device and are screens corresponding to multiple ROIs included in one source screen, the external electronic device may perform 1:N mirroring operation. For example, when the first mirroring screen 1110 and the second mirroring screen 1111 are received from one electronic device and are screens corresponding to multiple source screens of one electronic device, the external electronic device may perform N:N mirroring operation.

According to an embodiment, when the first mirroring screen 1110 is received from a first electronic device and the second mirroring screen 1111 is received from a second electronic device, the external electronic device may perform N:N mirroring operation.

FIG. 11B is a view illustrating an area displaying a mirroring screen of an external electronic device according to an embodiment of the disclosure.

Referring to FIG. 11B, the external electronic device may display a plurality of mirroring screens received from one electronic device or multiple electronic devices.

For example, when a screen of the external electronic device includes a pop-up screen, the external electronic device may display a first mirroring screen 1120 in the entire display area and display a second mirroring screen 1121 in the pop-up screen.

For example, when the first mirroring screen 1120 and the second mirroring screen 1121 are received from one electronic device and are screens corresponding to multiple ROIs included in one source screen, the external electronic device may perform 1:N mirroring operation. For example, when the first mirroring screen 1120 and the second mirroring screen 1121 are received from one electronic device and are screens corresponding to multiple source screens of one electronic device, the external electronic device may perform N:N mirroring operation.

According to an embodiment, when the first mirroring screen 1120 is received from a first electronic device and the second mirroring screen 1121 is received from a second electronic device, the external electronic device may perform N:N mirroring operation.

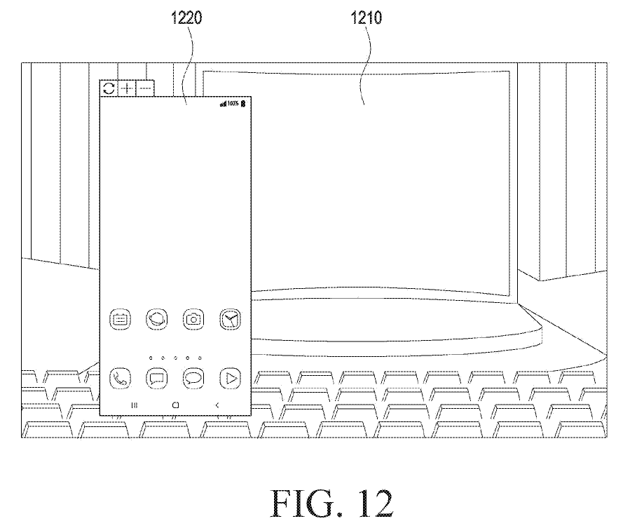

FIG. 12 is a view illustrating an area displaying a mirroring screen of an external electronic device according to an embodiment of the disclosure.

Referring to FIG. 12, an external electronic device (e.g., the electronic device 104 of FIG. 1) is a VR (or AR) device and may display a virtual environment 1210.

According to an embodiment, the external electronic device may display a mirroring screen 1220 in the form of a pop-up screen within the virtual environment 1210.

According to an embodiment, the pop-up screen may include a rotation button and zoom buttons (e.g., +/-) for changing configuration information of the pop-up screen. For example, the external electronic device may rotate the pop-up screen by +90 degrees each time a rotation button is selected based on a gesture input. For example, the external electronic device may increase or decrease the pop-up screen by a predetermined size between a minimum size and a maximum size each time a zoom button is selected based on a gesture input.

According to an embodiment, since the external electronic device changes the pop-up screen by a predetermined angle or predetermined size according to selection of the rotation button or zoom button, even without determining configuration information of the changed pop-up screen, the external electronic device may transmit configuration information including the changed angle or size to the electronic device when the rotation button or zoom button is selected.

According to an embodiment, the external electronic device may change the screen size and ratio of the pop-up screen through drag and drop of the pop-up screen via gesture input.

According to an embodiment, when configuration information of the pop-up screen is changed through drag and drop, the external electronic device may determine size information, ratio information, and/or resolution information of the changed pop-up screen after completing the change of the pop-up screen and then transmit the changed configuration information to the electronic device.

As such, the electronic device of the disclosure may recognize configuration information of a sink screen of an external electronic device and apply it to a mirroring screen, thereby providing an optimized mirroring screen experience to users without interruption. Further, the electronic device may provide an optimized mirroring screen experience to users without interruption by applying a transition effect to abnormal screens that occur during the configuration information change process.

According to an embodiment, an electronic device (e.g., the electronic device 101 of FIG. 1) may include a communication module (e.g., the communication module 190 of FIG. 1), a display (e.g., the display module 160 of FIG. 1), a processor (e.g., the processor 120 of FIG. 1), and memory (e.g., the memory 130 of FIG. 1) storing instructions that, when executed by the processor, cause the electronic device to perform the following operations.

According to an embodiment, the instructions may be configured to generate a virtual screen for mirroring a screen displayed on at least a partial area of the display based on configuration information related to a screen of an external electronic device connected through the communication module.

According to an embodiment, the instructions may be configured to transmit the generated virtual screen to the external electronic device through the communication module.

According to an embodiment, the instructions may be configured to receive changed configuration information from the external electronic device through the communication module while the virtual screen is being transmitted.

According to an embodiment, the instructions may be configured to change the virtual screen based on the changed configuration information.

According to an embodiment, the instructions may be configured to transmit the changed virtual screen to the external electronic device through the communication module.

According to an embodiment, the changed configuration information may include a ratio of a horizontal length and a vertical length of a screen of the external electronic device.

According to an embodiment, the instructions may be configured to change the horizontal length and the vertical length of the virtual screen based on the ratio.

According to an embodiment, the changed configuration information may include rotation information related to a rotation angle of the external electronic device.

According to an embodiment, the instructions may be configured to change the horizontal length and the vertical length of the virtual screen based on the rotation information.

According to an embodiment, the changed virtual screen may further include information indicating that the changed virtual screen reflects the changed configuration information.

According to an embodiment, the changed configuration information may further include second configuration information different from the configuration information.

According to an embodiment, the instructions may be configured to generate a second virtual screen based on the second configuration information.

According to an embodiment, the instructions may be configured to transmit the second virtual screen to the external electronic device through the communication module.

According to an embodiment, the instructions may be configured to transmit information about a plurality of areas of the display to the external electronic device.

According to an embodiment, the instructions may be configured to change the virtual screen to a virtual screen for mirroring a screen of the second area based on receiving the changed configuration information including information related to a second area different from a first area corresponding to the virtual screen from the external electronic device.

According to an embodiment, the instructions may be configured to transmit information related to types of changeable screen configuration to the external electronic device before performing negotiation for mirroring with the external electronic device.

According to an embodiment, an electronic device may be configured to include a communication module, a display, a processor, and memory storing instructions that, when executed by the processor, cause the electronic device to perform the following operations.

According to an embodiment, the instructions may be configured to receive first screen information related to a virtual screen mirroring a screen of an external electronic device connected through the communication module from the external electronic device.

According to an embodiment, the instructions may be configured to display a first screen generated based on the first screen information on at least a partial area of the display.

According to an embodiment, the instructions may be configured to transmit changed configuration information to the external electronic device based on configuration information of the display being changed while the first screen information is being received.

According to an embodiment, the instructions may be configured to generate a second screen corresponding to the changed configuration information based on second screen information received through the communication module after transmitting the changed configuration information.

According to an embodiment, the instructions may be configured to display the second screen on the display.

According to an embodiment, the instructions may be configured to change the configuration information based on at least one of rotation of the display or change of a window to display a screen generated based on the screen information.

According to an embodiment, the second screen information may further include information indicating that the changed configuration information is reflected.

According to an embodiment, the instructions may be configured to provide a transition effect to the first screen after changing configuration information of the display.

According to an embodiment, the instructions may be configured to terminate the transition effect and display the second screen based on the second screen information being received.

According to an embodiment, the instructions may be configured to change the configuration information based on receiving a user input for changing an area where the first screen is displayed while the first screen information is being received.

According to an embodiment, the instructions may be configured to receive information about a plurality of areas of a display of the external electronic device from the external electronic device.

According to an embodiment, the instructions may be configured to display the information about the plurality of areas on the display.

According to an embodiment, the instructions may be configured to change the configuration information to include information related to the second area based on receiving a user input selecting a second area different from a first area corresponding to the first screen among the plurality of areas.

According to an embodiment, the instructions may be configured to receive information related to types of changeable screen configuration from the external electronic device before performing negotiation for mirroring with the external electronic device.

According to an embodiment, a method of controlling an electronic device may include generating a virtual screen for mirroring a screen displayed on at least a partial area of a display of the electronic device based on configuration information related to a screen of an external electronic device connected through a communication module of the electronic device.

According to an embodiment, the method of controlling the electronic device may include transmitting the generated virtual screen to the external electronic device through the communication module.

According to an embodiment, the method of controlling the electronic device may include receiving changed configuration information from the external electronic device through the communication module while the virtual screen is being transmitted.

According to an embodiment, the method of controlling the electronic device may include changing the virtual screen based on the changed configuration information.

According to an embodiment, the method of controlling the electronic device may include transmitting the changed virtual screen to the external electronic device through the communication module.

According to an embodiment, the changed configuration information may include a ratio of a horizontal length and a vertical length of a screen of the external electronic device.

According to an embodiment, the operation of changing the virtual screen may change the horizontal length and the vertical length of the virtual screen based on the ratio.

According to an embodiment, the changed configuration information may include rotation information related to a rotation angle of the external electronic device.

According to an embodiment, the operation of changing the virtual screen may change the horizontal length and the vertical length of the virtual screen based on the rotation information.

According to an embodiment, the changed virtual screen may further include information indicating that the changed virtual screen reflects the changed configuration information.

According to an embodiment, the changed configuration information may further include second configuration information different from the configuration information.

According to an embodiment, the operation of changing the virtual screen may include generating a second virtual screen based on the second configuration information.

According to an embodiment, the operation of transmitting the changed virtual screen to the external electronic device may include transmitting the second virtual screen to the external electronic device through the communication module.

According to an embodiment, the method of controlling the electronic device may further include transmitting information about a plurality of areas of the display to the external electronic device.

According to an embodiment, the operation of changing the virtual screen may include changing the virtual screen to a virtual screen for mirroring a screen of the second area based on receiving the changed configuration information including information related to a second area different from a first area corresponding to the virtual screen from the external electronic device.

According to an embodiment, the method of controlling the electronic device may further include transmitting information related to types of changeable screen configuration to the external electronic device before performing negotiation for mirroring with the external electronic device.

According to an embodiment, the method of controlling the electronic device may include receiving first screen information related to a virtual screen mirroring a screen of an external electronic device connected through a communication module of the electronic device from the external electronic device.

According to an embodiment, the method of controlling the electronic device may include displaying a first screen generated based on the first screen information on at least a partial area of the display.

According to an embodiment, the method of controlling the electronic device may include transmitting changed configuration information to the external electronic device based on configuration information of a display of the electronic device being changed while the first screen information is being received.

According to an embodiment, the method of controlling the electronic device may include generating a second screen corresponding to the changed configuration information based on second screen information received through the communication module after transmitting the changed configuration information.

According to an embodiment, the method of controlling the electronic device may include displaying the second screen on the display.

According to an embodiment, the method of controlling the electronic device may further include changing the configuration information based on at least one of rotation of the display or change of a window to display a screen generated based on the screen information.

According to an embodiment, the second screen information may further include information indicating that the changed configuration information is reflected.

According to an embodiment, the method of controlling the electronic device may further include providing a transition effect to the first screen after changing configuration information of the display.

According to an embodiment, the operation of displaying the second screen on the display may terminate the transition effect and display the second screen based on the second screen information being received.

According to an embodiment, the method of controlling the electronic device may further include changing the configuration information based on receiving a user input for changing an area where the first screen is displayed while the first screen information is being received.

According to an embodiment, the method of controlling the electronic device may further include receiving information about a plurality of areas of a display of the external electronic device from the external electronic device.

According to an embodiment, the method of controlling the electronic device may further include displaying the information about the plurality of areas on the display.

According to an embodiment, the method of controlling the electronic device may further include changing the configuration information to include information related to the second area based on receiving a user input selecting a second area different from a first area corresponding to the first screen among the plurality of areas.

According to an embodiment, the method of controlling the electronic device may further include receiving information related to types of changeable screen configuration from the external electronic device before performing negotiation for mirroring with the external electronic device.

According to an embodiment, in a non-transitory computer-readable recording medium storing one or more programs, the one or more programs may include instructions causing an electronic device to generate a virtual screen for mirroring a screen displayed on at least a partial area of a display of the electronic device based on configuration information related to a screen of an external electronic device connected through a communication module of the electronic device.

According to an embodiment, the one or more programs may include instructions causing the electronic device to transmit the generated virtual screen to the external electronic device through the communication module.

According to an embodiment, the one or more programs may include instructions causing the electronic device to receive changed configuration information from the external electronic device through the communication module while the virtual screen is being transmitted.

According to an embodiment, the one or more programs may include instructions causing the electronic device to change the virtual screen based on the changed configuration information.

According to an embodiment, the one or more programs may include instructions causing the electronic device to transmit the changed virtual screen to the external electronic device through the communication module.

According to an embodiment, the changed configuration information may include a ratio of a horizontal length and a vertical length of a screen of the external electronic device.

According to an embodiment, the one or more programs may include instructions causing the electronic device to change the horizontal length and the vertical length of the virtual screen based on the ratio.

According to an embodiment, the changed configuration information may include rotation information related to a rotation angle of the external electronic device.

According to an embodiment, the one or more programs may include instructions causing the electronic device to change the horizontal length and the vertical length of the virtual screen based on the rotation information.

According to an embodiment, the changed virtual screen may further include information indicating that the changed virtual screen reflects the changed configuration information.

According to an embodiment, the changed configuration information may further include second configuration information different from the configuration information.

According to an embodiment, the one or more programs may include instructions causing the electronic device to generate a second virtual screen based on the second configuration information.

According to an embodiment, the one or more programs may include instructions causing the electronic device to transmit the second virtual screen to the external electronic device through the communication module.

According to an embodiment, the one or more programs may include instructions causing the electronic device to transmit information about a plurality of areas of the display to the external electronic device.

According to an embodiment, the one or more programs may include instructions causing the electronic device to change the virtual screen to a virtual screen for mirroring a screen of the second area based on receiving the changed configuration information including information related to a second area different from a first area corresponding to the virtual screen from the external electronic device.

According to an embodiment, the one or more programs may include instructions causing the electronic device to transmit information related to types of changeable screen configuration to the external electronic device before performing negotiation for mirroring with the external electronic device.

According to an embodiment, in a non-transitory computer-readable recording medium storing one or more programs, the one or more programs may include instructions causing an electronic device to receive first screen information related to a virtual screen mirroring a screen of an external electronic device connected through a communication module of the electronic device from the external electronic device.

According to an embodiment, the one or more programs may include instructions causing the electronic device to display a first screen generated based on the first screen information on at least a partial area of a display of the electronic device.

According to an embodiment, the one or more programs may include instructions causing the electronic device to transmit changed configuration information to the external electronic device based on configuration information of the display being changed while the first screen information is being received.

According to an embodiment, the one or more programs may include instructions causing the electronic device to generate a second screen corresponding to the changed configuration information based on second screen information received through the communication module after transmitting the changed configuration information.

According to an embodiment, the one or more programs may include instructions causing the electronic device to display the second screen on the display.

According to an embodiment, the one or more programs may include instructions causing the electronic device to change the configuration information based on at least one of rotation of the display or change of a window to display a screen generated based on the screen information.

According to an embodiment, the second screen information may further include information indicating that the changed configuration information is reflected.

According to an embodiment, the one or more programs may include instructions causing the electronic device to provide a transition effect to the first screen after changing configuration information of the display.

According to an embodiment, the one or more programs may include instructions causing the electronic device to terminate the transition effect and display the second screen based on the second screen information being received.

According to an embodiment, the one or more programs may include instructions causing the electronic device to change the configuration information based on receiving a user input for changing an area where the first screen is displayed while the first screen information is being received.

According to an embodiment, the one or more programs may include instructions causing the electronic device to receive information about a plurality of areas of a display of the external electronic device from the external electronic device.

According to an embodiment, the one or more programs may include instructions causing the electronic device to display the information about the plurality of areas on the display.

According to an embodiment, the one or more programs may include instructions causing the electronic device to change the configuration information to include information related to the second area based on receiving a user input selecting a second area different from a first area corresponding to the first screen among the plurality of areas.

According to an embodiment, the one or more programs may include instructions causing the electronic device to receive information related to types of changeable screen configuration from the external electronic device before performing negotiation for mirroring with the external electronic device.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” "coupled to," "connected with," or “connected to” another element (e.g., a second element), it means that the element may be coupled with the other element directly (e.g., wiredly), wirelessly, or via a third element.

As used herein, the term "module" may include a unit implemented in hardware, software, or firmware, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term "non-transitory" simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
communication circuitry;
a display;
memory, comprising one or more storage media, storing instructions; and
one or more processors communicatively coupled to the communication circuitry, the display and the memory,
wherein the instructions, when executed by the one or more processors individually or collectively, cause the electronic device to:
generate a virtual screen for mirroring a screen displayed on at least a partial area of the display based on configuration information related to a screen of an external electronic device connected through the communication circuitry,
transmit the generated virtual screen to the external electronic device through the communication circuitry,
receive changed configuration information from the external electronic device through the communication circuitry while the virtual screen is being transmitted,
change the virtual screen based on the changed configuration information, and
transmit the changed virtual screen to the external electronic device through the communication circuitry.

2. The electronic device of claim 1,
wherein the changed configuration information includes a ratio of a horizontal length and a vertical length of a screen of the external electronic device, and
wherein the instructions, when executed by the one or more processors individually or collectively, further cause the electronic device to change the horizontal length and the vertical length of the virtual screen based on the ratio.

3. The electronic device of claim 1,
wherein the changed configuration information includes rotation information related to a rotation angle of the external electronic device, and
wherein the instructions, when executed by the one or more processors individually or collectively, further cause the electronic device to change a horizontal length and a vertical length of the virtual screen based on the rotation information.

4. The electronic device of claim 1, wherein the changed virtual screen further includes information indicating that the changed virtual screen reflects the changed configuration information.

5. The electronic device of claim 1,
wherein the changed configuration information further includes second configuration information different from the configuration information, and
wherein the instructions, when executed by the one or more processors individually or collectively, further cause the electronic device to:
generate a second virtual screen based on the second configuration information, and
transmit the second virtual screen to the external electronic device through the communication circuitry.

6. The electronic device of claim 1, wherein the instructions, when executed by the one or more processors individually or collectively, further cause the electronic device to:
transmit information on a plurality of areas of the display to the external electronic device, and
change, based on receiving the changed configuration information including information related to a second area that is different from a first area corresponding to the virtual screen from the external electronic device, the virtual screen to a virtual screen for mirroring a screen of the second area.

7. The electronic device of claim 1, wherein the instructions are configured to:
transmit information related to a type of changeable screen configuration to the external electronic device before negotiating for mirroring with the external electronic device.

8. An electronic device, comprising:
communication circuitry;
a display;
memory, comprising one or more storage media, storing instructions; and
one or more processors communicatively coupled to the communication circuitry, the display and the memory
wherein the instructions, when executed by the one or more processors individually or collectively, cause the electronic device to:
receive first screen information related to a virtual screen mirroring a screen of an external electronic device connected through the communication circuitry from the external electronic device,
display a first screen generated based on the first screen information on at least a partial area of the display,
transmit changed configuration information to the external electronic device based on configuration information of the display being changed while the first screen information is being received,
generate a second screen corresponding to the changed configuration information based on second screen information received through the communication circuitry after transmitting the changed configuration information, and
display the second screen on the display.

9. The electronic device of claim 8, wherein the instructions, when executed by the one or more processors individually or collectively, further cause the electronic device to change the configuration information based on at least one of rotation of the display or a change of a window to display a screen generated based on the first screen information.

10. The electronic device of claim 8,
wherein the second screen information further includes information indicating that the changed configuration information is reflected, and
wherein the instructions, when executed by the one or more processors individually or collectively, further cause the electronic device to:
after changing the configuration information of the display, provide a transition effect to the first screen, and
based on the second screen information being received, terminate the transition effect and display the second screen.

11. The electronic device of claim 8, wherein the instructions, when executed by the one or more processors individually or collectively, further cause the electronic device to change the configuration information based on receiving a user input for changing an area where the first screen is displayed while the first screen information is being received.

12. The electronic device of claim 8, wherein the instructions, when executed by the one or more processors individually or collectively, further cause the electronic device to:
receive information about a plurality of areas of a display of the external electronic device from the external electronic device,
display the information on the plurality of areas on the display, and
change, based on receiving a user input for selecting a second area different from a first area corresponding to the first screen among the plurality of areas, the configuration information to include information related to the second area.

13. The electronic device of claim 8, wherein the instructions, when executed by the one or more processors individually or collectively, further cause the electronic device to receive information related to a type of changeable screen configuration from the external electronic device before negotiating for mirroring with the external electronic device.

14. A method performed by an electronic device, comprising:
generating, by the electronic device, a virtual screen for mirroring a screen displayed on at least a partial area of a display of the electronic device based on configuration information related to a screen of an external electronic device connected through communication circuitry of the electronic device;
transmitting, by the electronic device, the generated virtual screen to the external electronic device through the communication circuitry;
receiving, by the electronic device, changed configuration information from the external electronic device through the communication circuitry while the virtual screen is being transmitted;
changing, by the electronic device, the virtual screen based on the changed configuration information; and
transmitting, by the electronic device, the changed virtual screen to the external electronic device through the communication circuitry.

15. The method of claim 14,
wherein the changed configuration information includes a ratio of a horizontal length and a vertical length of a screen of the external electronic device, and
wherein the changing of the virtual screen changes the horizontal length and the vertical length of the virtual screen based on the ratio.

16. The method of claim 14,
wherein the changed configuration information includes rotation information related to a rotation angle of the external electronic device, and
wherein the changing of the virtual screen changes a horizontal length and a vertical length of the virtual screen based on the rotation information.

17. The method of claim 14, wherein the changed virtual screen further includes information indicating that the changed virtual screen reflects the changed configuration information.

18. The method of claim 14,
wherein the changed configuration information further includes second configuration information different from the configuration information, and
wherein the method further comprises:
generating a second virtual screen based on the second configuration information; and
transmitting the second virtual screen to the external electronic device through the communication circuitry.

19. One or more non-transitory computer-readable storage media storing one or more computer programs including computer-executable instructions that, when executed by one or more processors of an electronic device individually or collectively, cause the electronic device to perform operations, the operations comprising:
generating, by the electronic device, a virtual screen for mirroring a screen displayed on at least a partial area of a display of the electronic device based on configuration information related to a screen of an external electronic device connected through communication circuitry of the electronic device;
transmitting, by the electronic device, the generated virtual screen to the external electronic device through the communication circuitry;
receiving, by the electronic device, changed configuration information from the external electronic device through the communication circuitry while the virtual screen is being transmitted;
changing, by the electronic device, the virtual screen based on the changed configuration information; and
transmitting, by the electronic device, the changed virtual screen to the external electronic device through the communication circuitry.

20. The one or more non-transitory computer-readable storage media of claim 19,
wherein the changed configuration information includes a ratio of a horizontal length and a vertical length of a screen of the external electronic device, and
wherein the changing of the virtual screen changes the horizontal length and the vertical length of the virtual screen based on the ratio.
